(19) United States
(12) Patent Application Publication
(10) Pub. No.: US 2024/0422235 A1
(43) Pub. Date: Dec. 19, 2024

(54) INFORMATION DELIVERY SYSTEM INCLUDING DELIVERY DESTINATION DEVICE AND DELIVERY PROVISION SERVER PROVIDING DELIVERY INFORMATION TO DELIVERY DESTINATION DEVICE

(71) Applicant: BROTHER KOGYO KABUSHIKI KAISHA, Nagoya (JP)

(72) Inventors: Tetsuya OKUNO, Nagoya (JP); Yuka ISHIHARA, Nagoya (JP); Yushi ICHIKAWA, Nagoya (JP); Yutaka TAKIJIRI, Nagoya (JP); Hiroki SUMI, Nagoya (JP); Sohei YAMAMOTO, Koka (JP); Rie KUDO, Nagoya (JP); Ryo MURASE, Ama (JP)

(21) Appl. No.: 18/742,341

(22) Filed: Jun. 13, 2024

(30) Foreign Application Priority Data
Jun. 16, 2023 (JP) 2023-099579

(51) Int. Cl. H04L 67/51; G06Q 30/08

(52) U.S. Cl. CPC H04L 67/51; G06Q 30/08

(57) ABSTRACT

An information delivery system includes a delivery provision server and a delivery destination device. The delivery provision server includes a controller configured to: select a first piece of layout information from a plurality of pieces of layout information; acquire one or more pieces of first information for one or more first delivery frames defined by the first piece of layout information; create, when determining for each of the one or more first delivery frames that a piece of first information is placeable in the first delivery frames from among at least one piece of first information acquired for the first delivery frame, first delivery information in which the one or more first delivery frames are arranged according to the first piece of layout information with each placeable piece of first information placed in the corresponding first delivery frame; and provide the created first delivery information to the delivery destination device.

### REFERENCE TO RELATED APPLICATIONS

This application claims priority from Japanese Patent Application No. 2023-099579 filed on Jun. 16, 2023. The entire content of the priority application is incorporated herein by reference.

### BACKGROUND ART

There have been known personalized media services that produce printed matter or other hardcopy media. When the service provider in the conventional technology receives a media selection from a user, the service queries advertisement providers for advertisements to print along with this media. The service provider acquires electronic copies of advertisements from advertisement providers that successfully bid on the advertising space and combines these electronic copies with the electronic copy of the media in order that the advertisements are printed together with the media.

### SUMMARY

However, since the service provider accepts bids for advertisements as information and arranges this information based on a fixed predetermined layout, there are limitations in the layout of advertisements being printed.

In view of the foregoing, it is an object of the present disclosure to provide an information delivery system and a delivery provision server that can improve flexibility in the layout of information to be printed or displayed in accordance with bids.

In order to attain the above and other objects, according to one aspect, the present disclosure provides an information delivery system including a delivery destination device and a delivery provision server. The delivery provision server includes a communication interface, a memory, and a controller. The memory stores therein a plurality of pieces of layout information including a first piece of layout information and a second piece of layout information. The first piece of layout information and the second piece of layout information are different from each other. The first piece of layout information defines one or more first delivery frames for placing information therein. Each of the one or more first delivery frames is associated with a respective first frame condition. Each first frame condition is a condition required for successfully bidding for the corresponding first delivery frame. The second piece of layout information defines one or more second delivery frames for placing information therein. Each of the one or more second delivery frames is associated with a respective second frame condition. Each second frame condition is a condition required for successfully bidding for the corresponding second delivery frame. The controller is configured to perform a first layout selection process including selecting the first piece of layout information from among the plurality of pieces of layout information stored in the memory. The controller is configured to perform a first information acquisition process including acquiring one or more pieces of first information for the one or more first delivery frames by acquiring at least one piece of first information for each of the one or more first delivery frames. Each of the one or more pieces of first information being information satisfies the first frame condition of the corresponding first delivery frame. The controller is configured to perform a first determination process on the basis of the one or more pieces of first information acquired in the first information acquisition process. The first determination process includes determining, for each of all of the one or more first delivery frames defined by the first piece of layout information, whether a piece of first information is placeable in the first delivery frame from among the at least one piece of first information acquired for the first delivery frame in the first information acquisition process. The controller is configured to perform a first creation process when determining in the first determination process for each of all of the one or more first delivery frames that a piece of first information is placeable in the first delivery frame from among the at least one piece of first information acquired for the first delivery frame. The first creation process includes creating first delivery information in which the one or more first delivery frames are arranged according to the first piece of layout information and each piece of first information that is determined in the first determination process to be placeable is placed in the corresponding first delivery frame. The controller is configured to perform an information provision process in response to creating the first delivery information in the first creation process. The information provision process includes providing the first delivery information created in the first creation process to the delivery destination device. The controller is configured to perform a second information acquisition process when determining in the first determination process for at least one of the one or more first delivery frames that no piece of first information is placeable in the first delivery frame from among the at least one piece of first information acquired for the first delivery frame. The second information acquisition process includes acquiring one or more pieces of second information for the one or more second delivery frames by acquiring at least one piece of second information for each of the one or more second delivery frames. Each of the one or more pieces of second information being information satisfying the second frame condition of the corresponding second delivery frame.

In the above configuration, when one or more pieces of first information cannot be placed according to the first piece of layout information, the controller acquires one or more pieces of second information to place according to the second piece of layout information different from the first piece of layout information. This process can further increase the flexibility in laying out information and can provide information in a wider variety of layouts, compared to a configuration in which information is arranged based on a predetermined fixed layout.

According to another aspect, the present disclosure provides a delivery provision server including a communication interface, a memory, and a controller. The memory stores therein a plurality of pieces of layout information including a first piece of layout information and a second piece of layout information. The first piece of layout information and the second piece of layout information are different from each other. The first piece of layout information defines one or more first delivery frames for placing information therein. Each of the one or more first delivery frames is associated with a respective first frame condition. Each first frame condition is a condition required for successfully bidding for the corresponding first delivery frame. The second piece of layout information defines one or more second delivery frames for placing information therein. Each of one or more second delivery frames is associated with a respective second frame condition. Each second frame condition is a condition required for successfully bidding for the corresponding second delivery frame. The controller is configured to perform a first layout selection process including selecting the first piece of layout information from among the plurality of pieces of layout information stored in the memory. The controller is configured to perform a first information acquisition process including acquiring one or more pieces of first information for the one or more first delivery frames by acquiring at least one piece of first information for each of the one or more first delivery frames. Each of the one or more pieces of first information is information satisfying the first frame condition of the corresponding first delivery frame. The controller is configured to perform a first determination process on the basis of the one or more pieces of first information acquired in the first information acquisition process. The first determination process includes determining, for each of all of the one or more first delivery frames defined by the first piece of layout information, whether a piece of first information is placeable in the first delivery frame from among the at least one piece of first information acquired for the first delivery frame in the first information acquisition process. The controller is configured to perform a first creation process when determining in the first determination process for each of all of the one or more first delivery frames that a piece of first information is placeable in the first delivery frame from among the at least one piece of first information acquired for the first delivery frame. The first creation process includes creating first delivery information in which the one or more first delivery frames are arranged according to the first piece of layout information and each piece of first information that is determined in the first determination process to be placeable is placed in the corresponding first delivery frame. The controller is configured to perform an information provision process in response to creating the first delivery information in the first creation process. The information provision process includes providing the first delivery information created in the first creation process to a delivery destination device. The controller is configured to perform a second information acquisition process when determining in the first determination process for at least one of the one or more first delivery frames that no piece of first information is placeable in the first delivery frame from among the at least one piece of first information acquired for the first delivery frame. The second information acquisition process includes acquiring one or more pieces of second information for the one or more second delivery frames by acquiring at least one piece of second information for each of the one or more second delivery frames. Each of the one or more pieces of second information is information satisfying the second frame condition of the corresponding second delivery frame.

In the above configuration, when one or more pieces of first information cannot be placed according to the first piece of layout information, the controller acquires one or more pieces of second information to place according to the second piece of layout information different from the first piece of layout information. This process can further increase the flexibility in laying out information and can provide information in a wider variety of layouts, compared to a configuration in which information is arranged based on a predetermined fixed layout.

### BRIEF DESCRIPTION OF DRAWINGS

FIG. 1 is a block diagram illustrating an example of the overall configuration of an information delivery system.

FIG. 2 is a sequence chart illustrating an example of steps in a process executed by an advertisement provision server, an advertisement management server, a user management server, and a printer in cooperation with each other.

FIGS. 3A-3D are explanatory diagrams conceptually illustrating an example of a process flow for resolicitation of bids in a delivery image creation process.

FIGS. 4A-4D are explanatory diagrams conceptually illustrating another example of a process flow for resolicitation of bids in the delivery image creation process.

FIGS. 5A-5D are explanatory diagrams conceptually illustrating still another example of a process flow for resolicitation of bids in the delivery image creation process.

FIG. 6 is a flowchart of a process executed in the delivery image creation process by a control unit of the advertisement provision server.

FIGS. 7A-7C are explanatory diagrams conceptually illustrating an example of a process flow for resolicitation of bids in a delivery image creation process executed in an information delivery system in which the minimum bid prices are dynamically changed.

FIGS. 8A-8D are explanatory diagrams conceptually illustrating an example of a process flow for resolicitation of bids in a delivery image creation process executed in an information delivery system in which delivery frames are set as time frames.

### DESCRIPTION

An embodiment of the present disclosure will be described while referring to the accompanying drawings. In this embodiment, the present disclosure is applied to an information delivery system that distributes advertisement information from a server to printers for printing.

### <Overall Configuration of Information Delivery System>

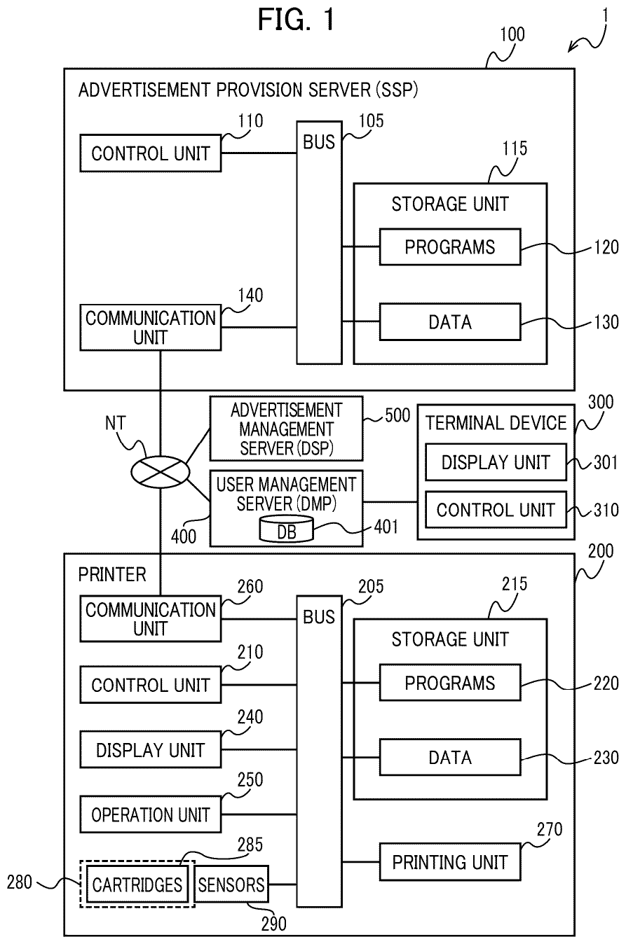

FIG. 1 shows an example of the overall configuration of an information delivery system 1 according to the present embodiment. As shown in FIG. 1, the information delivery system 1 includes an advertisement provision server (SSP: a supply-side platform) 100, a printer 200, a terminal device 300, a user management server (DMP: a data management platform) 400, and an advertisement management server (DSP: a demand-side platform) 500. The servers 100, 400, and 500, the printer 200, and the terminal device 300 each include a communication unit and can communicate with each other over a network NT. The network NT includes at least one of the Internet, a local area network (LAN), and a wide area network (WAN). The communication units may include a plurality of types of communication circuits for connecting to the network NT. In this case, each device connected to the network NT may communicate with a plurality of other devices using different communication circuits. In the present embodiment, the different types of communication circuits are collectively referred to as the communication unit.

### <Terminal Device>

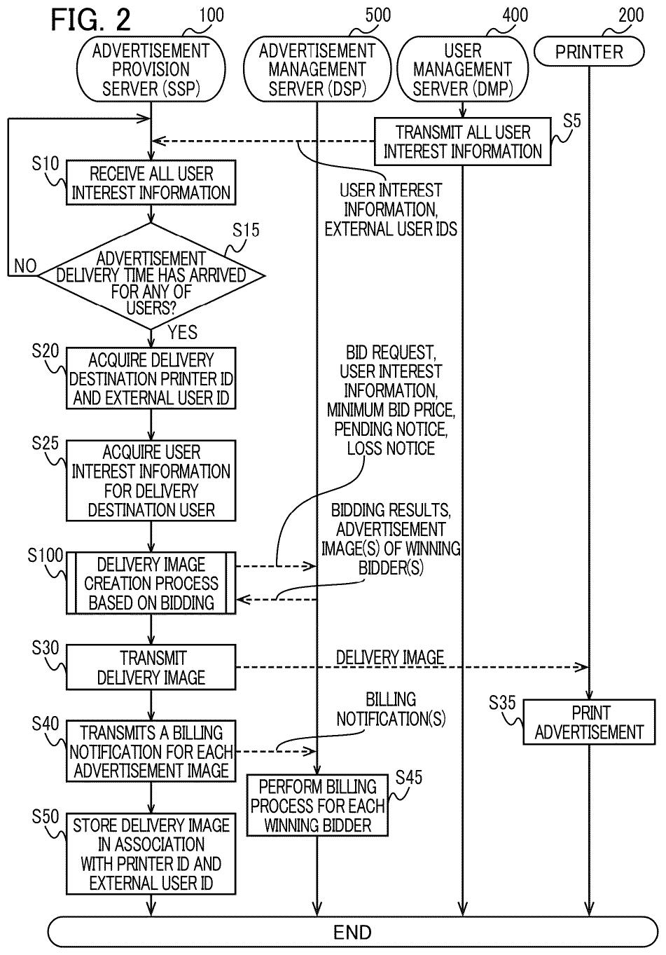

The terminal device 300 is a smartphone or other portable device owned by the user, for example. In this example, the terminal device 300 is configured to be connected to the user management server 400 via a wireless connection. In addition to a smartphone, the terminal device 300 may be a tablet computer, a laptop computer, a desktop computer, or the like. Alternatively, the terminal device 300 may be configured to be connected to the network NT. The terminal device 300 includes a display unit 301 and a control unit 310. While not shown in the drawings, the terminal device 300 also includes an operation unit, a storage unit, a communication unit, and the like. The storage unit stores various programs. The control unit 310 executes the various programs stored in the storage unit. These programs include a program for implementing the process shown in the flowchart of FIG. 2 described later.

The display unit 301 is configured of a touchscreen that also serves as an operation unit by a touchpad integrally combined with a liquid crystal display, for example. The display unit 301 displays various information and receives various input operations from the user.

The user can input various instructions into the terminal device 300 by operating the touchscreen. The user can also receive external services from outside the system via the Internet through operations on the touchscreen. Each user is assigned an external user ID when the user receives any of various external services, the external user ID being identification information unique to the user. The external user ID is stored in the storage unit in association with the printer 200 designated by the user, e.g., the printer ID of the printer 200 used by this user.

### <User Management Server>

The user management server 400 is connected to the network NT. The user management server 400 manages behavioral information of each user. The behavioral information is information about actions taken by the user through the terminal device 300. Although not shown in the drawings, the user management server 400 includes a control unit, a storage unit, a communication unit, and the like. Examples of behavioral information include various histories of actions taken by the user through the terminal device 300, such as the user's website browsing history, website search history, web advertisement display history, website click history, website purchase history, and the like. The user's behavioral information is associated with the external user ID of that user and can be identified by the external user ID. The behavioral information for all users who utilize external services is stored in a behavioral information database 401 in the storage unit. In the behavioral information database 401, the behavioral information of each user is associated with the external user ID of the user.

In the present embodiment, the behavioral information that has been associated with the external user ID of each user is further converted and compiled into a form of corresponding user interest information. The user interest information specifies items of interest to the user. The items of interest to users have been preset in association with the above behavioral information contents. Examples of the items of interest include “cars,” “health,” “travel,” “food,” “saving money,” and the like. The user interest information may also include information specifying the location of the user inferred from content of the behavioral information. In the case of a middle-aged male user, for example, the external user ID may be associated with “cars,” “health,” and the like based on the user's browsing history and other behavioral information. In the case of a female user in her 20s, for example, the external user ID may be associated with “travel,” “food,” and the like based on the user's browsing history and other behavioral information. If the user is a male high school student, for example, the external user ID may be associated with “cars,” “saving money,” and the like based on the user's browsing history and other behavioral information. The user interest information associated with each external user ID in this way is transmitted to the advertisement provision server 100 via the communication unit.

### <Advertisement Provision Server>

The advertisement provision server 100 is connected to the network NT. For example, the advertisement provision server 100 is a server that is installed and managed by the manufacturer of the printer 200. At prescribed timings, the advertisement provision server 100 acquires the user interest information associated with the external user ID that corresponds to the printer ID of the printer 200 that is the target of delivery, and acquires an advertisement image tailored to this user interest information from the advertisement management server 500. The advertisement provision server 100 then delivers the acquired advertisement image to the printer 200 to cause the printer 200 to print the advertisement image. The advertisement provision server 100 is an example of the delivery provision server. The advertisement image is an example of the information managed by the delivery management server.

More specifically, the advertisement provision server 100 includes a control unit 110, a storage unit 115, and a communication unit 140. The control unit 110 is an example of the controller. The communication unit 140 is an example of the communication interface. The storage unit 115 is an example of the memory. The control unit 110, storage unit 115, communication unit 140, and the like are connected via a bus 105 and can exchange information with each other. The storage unit 115 is configured of RAM, ROM, EEPROM, a hard disk drive, and the like, for example. The storage unit 115 stores therein various programs 120, and various data 130. The programs 120 include an information delivery program for controlling the advertisement provision server 100 to implement a control process according to the flowchart of FIG. 2 described later. The data 130 includes the user interest information described above, the printer ID for the printer 200, external user IDs, and advertisement images. This printer ID is associated with the external user IDs for all users that use the printer 200. Note that the printer 200 is used by one or more users.

The control unit 110 is a device, such as a CPU or other processor, that performs data processing. The control unit 110 executes the various programs stored in the storage unit 115. The control unit 110 implements various processes including data communications with the printer 200, terminal device 300, user management server 400, and advertisement management server 500 which are connected to the network NT. The communication unit 140 is connected to the network NT and communicates with the printer 200, user management server 400, and advertisement management server 500.

### <Advertisement Management Server>

The advertisement management server 500 is connected to the network NT. The advertisement management server 500 transmits advertisement images to be printed by the printer 200 to the advertisement provision server 100. While not shown in the drawings, the advertisement management server 500 includes a control unit, a storage unit, and a communication unit. In this example, the advertisement management server 500 receives a bid request from the advertisement provision server 100 via the communication unit. The terminal devices or servers (not shown) of a plurality of advertisers are connected to the network NT. The control unit of the advertisement management server 500 holds an auction through the terminal devices and the like of the advertisers in response to the above bid request and obtains advertisement images suited to the user interest information through bids from the participating advertisers. The advertisement management server 500 may acquire the behavioral information from the user management server 400 instead of the user interest information and may acquire advertisement images suited to this behavioral information through bids in the auction. When there is a winning bid that meets predetermined conditions of the auction, the control unit of the advertisement management server 500 acquires the corresponding advertisement image from the terminal device or the like of the advertiser who is the winning bidder. After acquiring this advertisement image, the advertisement management server 500 transmits this image to the advertisement provision server 100 via the communication unit, the advertisement provision server 100 transfers the image to the printer 200, and the printer 200 prints the image. The advertisement management server 500 is an example of the delivery management server.

The servers 100, 400, and 500 may each be configured as a standalone server or may each be configured of a cluster of multiple servers. Alternatively, a single standalone server may be provided with the functions of two or more of the servers 100, 400, and 500.

### <Printer>

The printer 200 is assigned the printer ID described above. For example, the printer ID is the serial number of the printer 200. The printer 200 is an example of the delivery destination device. The printer 200 includes a control unit 210, a storage unit 215, a display unit 240, an operation unit 250, a communication unit 260, and a printing unit 270. The control unit 210, storage unit 215, display unit 240, operation unit 250, communication unit 260, and printing unit 270 are interconnected via a bus 205 and can exchange information with each other.

The storage unit 215 is configured of RAM, ROM, EEPROM, and a hard disk drive, for example. The storage unit 215 stores therein various programs 220, and various data 230. The programs 220 include a program for controlling the printer 200 to perform a control process according to the flowchart of FIG. 2 described later, for example. The data 230 includes the printer ID described above, and advertisement images received from the advertisement provision server 100, and specifically advertisement images that have been acquired from the terminal devices or the like of winning bidders among advertisers participating in auctions and that have been relayed by the advertisement provision server 100. Note that the printer ID is the identification information of the printer 200. In addition to the above information, the storage unit 215 may store other information on the printer 200 including performance information related to monochrome/color printing, specification information, intended use information such as whether the printer is intended for home use or office use, and destination information indicating the intended country of use. The storage unit 215 may also store the number of sheets printed by the printing unit 270 and the like.

The control unit 210 is a device, such as a CPU or other processor, that performs data processing. The control unit 210 executes the various programs stored in the storage unit 215. The display unit 240 is a liquid crystal display, for example, that can display various information. The operation unit 250 is configured of a keyboard and buttons, for example, and receives input operations from the user. By operating the operation unit 250, the user can input various instructions into the printer 200. The communication unit 260 is connected to the network NT and can communicate with the advertisement provision server 100, advertisement management server 500, user management server 400, and terminal device 300. The printing unit 270 includes a printing engine. The printing unit 270 prints an image on a sheet of printing paper according to the inkjet method while feeding and conveying the sheet from a paper tray with a conveying mechanism (not shown), for example. The sheet of printing paper is an example of the sheet.

The printer 200 also includes a cartridge holder 280. The cartridge holder 280 can accommodate a plurality of cartridges 285. The cartridges 285 include cartridges for a plurality of ink colors, including cyan, magenta, yellow, and black, for example. The cartridge holder 280 includes ink level sensors (not shown) that can detect the residual quantities or consumed quantities of ink in the respective cartridges 285 for the plurality of ink colors according to a known method.

The printing unit 270 performs printing processes while consuming ink from the cartridges 285. The printing unit 270 also includes cartridge sensors 290. The cartridge sensors 290 is provided at the cartridge holder 280. Each cartridge sensor 290 reads cartridge information from and writes cartridge information to an IC chip provided on the corresponding one of the cartridges 285. The cartridge sensor 290 detects the type and the like of the corresponding cartridge 285 accommodated in the cartridge holder 280 by reading cartridge information from the corresponding IC chip, for example. The cartridge sensor 290 may also detect a used amount or residual amount of ink in the cartridge 285 by reading the IC chip.

### <Process Flow>

In the information delivery system 1 of the present embodiment, the advertisement provision server 100 first stores external user IDs in the storage unit 115 in association with the printer ID.

Specifically, when the advertisement provision server 100 receives a request from a browser running on the terminal device 300 for a web page on an advertisement delivery service, the advertisement provision server 100 transmits display information for that web page to the terminal device 300. The terminal device 300 uses this display information to display a web page screen on the display unit 301. Based on operations the user performs in the web page screen, the terminal device 300 receives input specifying an external user ID and the printer ID of the printer 200 (the advertisement delivery destination) targeted for advertisement delivery, and transmits the received input information to the advertisement provision server 100. The advertisement provision server 100 stores the external user ID and printer ID received from the terminal device 300 in the storage unit 115 in association with each other.

At this time, the advertisement provision server 100 may receive advertisement delivery times from the terminal device 300 indicating the user's desired delivery schedule in response to user operations in the web page screen and may store these advertisement delivery times in the storage unit 115 in association with the external user ID.

In the information delivery system 1 in which the external user ID is associated with the printer ID as described above, the advertisement provision server 100 acquires the user interest information linked to the external user ID, receives from the advertisement management server 500 advertisement images tailored to the user interest information corresponding to the printer ID of the printer 200 that is the delivery destination, and transmits the advertisement images to the printer 200. After receiving the advertisement images, the printer 200 prints the received advertisement images. Next, the control sequence executed through cooperation among the advertisement provision server 100, advertisement management server 500, user management server 400, and printer 200 to implement this process flow will be described with reference to the sequence chart in FIG. 2.

When the advertisement provision server 100 requests user interest information related to external user IDs from the user management server 400, in S5 the user management server 400 transmits user interest information for all users, which is generated based on their behavioral information as described above, to the advertisement provision server 100 together with the corresponding external user IDs. For example, the process of S5 may be executed periodically at fixed intervals, or at other appropriate timings. The user interest information for all users sent by the user management server 400 is received by the advertisement provision server 100 in S10.

In S15 the advertisement provision server 100 determines whether an advertisement delivery time has arrived for any of the users for whom user interest information has been received in S10. In the present embodiment, advertisement delivery times, which are the times that advertisements are printed and provided to a user, are determined for each user in advance. For example, the external user IDs for all users, the printer IDs for the corresponding printers 200, and the corresponding advertisement delivery times are associated with each other and stored in the storage unit 115 as correlations. Thus, in S15 the advertisement provision server 100 determines based on the correlations whether the current time corresponds to an advertisement delivery time for any user.

When the current time does not correspond to an advertisement delivery time for any user (S15: NO), the advertisement provision server 100 returns to S10 and repeats the same process by again receiving user interest information for all users transmitted in S5. When the advertisement provision server 100 determines that the current time coincides with an advertisement delivery time for any user (S15: YES), the process advances to S20.

In S20 the advertisement provision server 100 identifies and acquires the external user ID corresponding to the determination results in S15, and the printer ID corresponding that external user ID. In S25 the advertisement provision server 100 identifies and acquires user interest information for the user corresponding to the external user ID obtained in S20 from the user interest information for all users received in S10.

In S100 the advertisement provision server 100, in cooperation with the advertisement management server 500, performs a delivery image creation process for creating an advertisement image to be printed by the printer 200 based on bids from advertisers.

### <Resolicitation of Bids in the Image Creation Process>

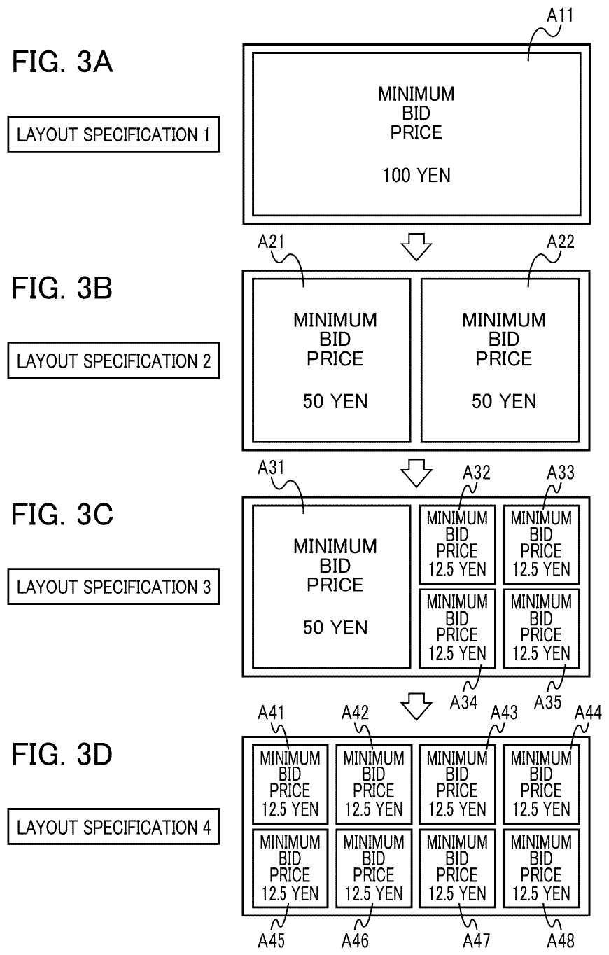

One feature of this embodiment is that when no bids received when soliciting bids from advertisers meet the predetermined winning bid conditions, bids are solicited again after dividing the unit space available for advertisements in one print, i.e., after dividing the advertisement printing area on printing paper of a predetermined size. An example of the process flow for this resolicitation of bids will be described with reference to FIGS. 3A-3D. The advertisement provision server 100 executes this process within the delivery image creation process of S100, which is a main element of this embodiment.

### <Layout Specification 1>

The example shown in FIG. 3A illustrates a layout specification 1, which is a layout specification used when soliciting bids with a layout having one advertisement printing area equivalent in size to nearly the entire A4-size sheet of paper, and one advertisement placement frame A11 set for the advertisement printing area. That is, the layout specification 1 defines the advertisement placement frame A11. In this example, bids are solicited with the minimum bid price for the advertisement placement frame A11 set at 100 yen. When a winning bid of 100 yen or more is placed for the advertisement placement frame A11 in response to this bid solicitation with the layout specification 1, a delivery image in which the advertisement image of the winning advertiser (i.e., the advertiser who is the winning bidder) is placed in the advertisement placement frame A11 is sent to the printer 200. Based on this delivery image, the printer 200 outputs, as the printed matter, one sheet of A4-size paper on which the single advertisement image is printed according to the layout specification 1.

### <Layout Specification 2>

When bidding in response to the bid solicitation using the layout specification 1 shown in FIG. 3A is unsuccessful, i.e., when no bids are received or when bids are placed but all are under 100 yen, bids are resolicited using a layout specification 2 shown in FIG. 3B. According to the layout specification 2, two advertisement placement frames A21 and A22 of equal size are set in the advertisement printing area described above. That is, the layout specification 2 defines the advertisement placement frames A21 and A22. The advertisement placement frames A21 and A22 are configured by dividing the advertisement placement frame A11 in FIG. 3A into two frames of equal size juxtaposed side-by-side in the left-right direction, where the advertisement placement frames A21 and A22 are each half the size of the advertisement placement frame A11. In this example, bids are solicited with the minimum bid price set at 50 yen for each of the advertisement placement frames A21 and A22.

When both of the advertisement placement frames A21 and A22 receive winning bids of 50 yen or more in response to the bid solicitation with the layout specification 2 (hereinafter referred to as an “all-frame bidding success state” for convenience), a delivery image having the advertisement images of the winning advertisers laid out in the advertisement placement frames A21 and A22, respectively, is sent to the printer 200. Based on this delivery image, the printer 200 outputs, as the printed matter, one sheet of A4-size paper on which the two advertisement images are printed according to the layout specification 2.

### <Layout Specification 3>

On the other hand, when bidding in response to the bid solicitation with the layout specification 2 does not produce an all-frame bidding success state, bids are resolicited using a layout specification 3 shown in FIG. 3C. Bidding results that do not produce an all-frame bidding success state include cases in which there are no bids for either of the advertisement placement frames A21 and A22, cases in which there are bids for one of the advertisement placement frames A21 and A22 but not the other, and cases in which there are bids for both of the advertisement placement frames A21 and A22 but at least one of the bid prices for the advertisement placement frames A21 and A22 is less than 50 yen.

In the layout specification 3, one advertisement placement frame A31, which is of equal size to the advertisement placement frames A21 and A22, and four advertisement placement frames A32, A33, A34, and A35 are arranged in the advertisement printing area. That is, the layout specification 3 defines the advertisement placement frames A31-A35. Each of the advertisement placement frames A32, A33, A34, and A35 is equivalent in size to one division of the advertisement placement frame A11 in FIG. 3A when divided into eight equal parts, or one division of either the advertisement placement frame A21 or A22 in FIG. 3B when divided into four equal parts. In this example, bids are solicited with the minimum bid price for the advertisement placement frame A31 set to 50 yen, which is the same as for the advertisement placement frames A21 and A22, and the minimum bid price for each of the advertisement placement frames A32, A33, A34, and A35 set to 12.5 yen.

When bidding in response to the bid solicitation with the layout specification 3 enters an all-frame bidding success state in which all of the advertisement placement frames A31-A35 have winning bids at a bid price satisfying the minimum bid price, a delivery image in which the advertisement images of the winning advertisers are placed in the corresponding advertisement placement frames A31-A35 is sent to the printer 200. Based on this delivery image, the printer 200 outputs, as printed matter, one sheet of A4-size paper in which the five advertisement images are printed according to the layout specification 3.

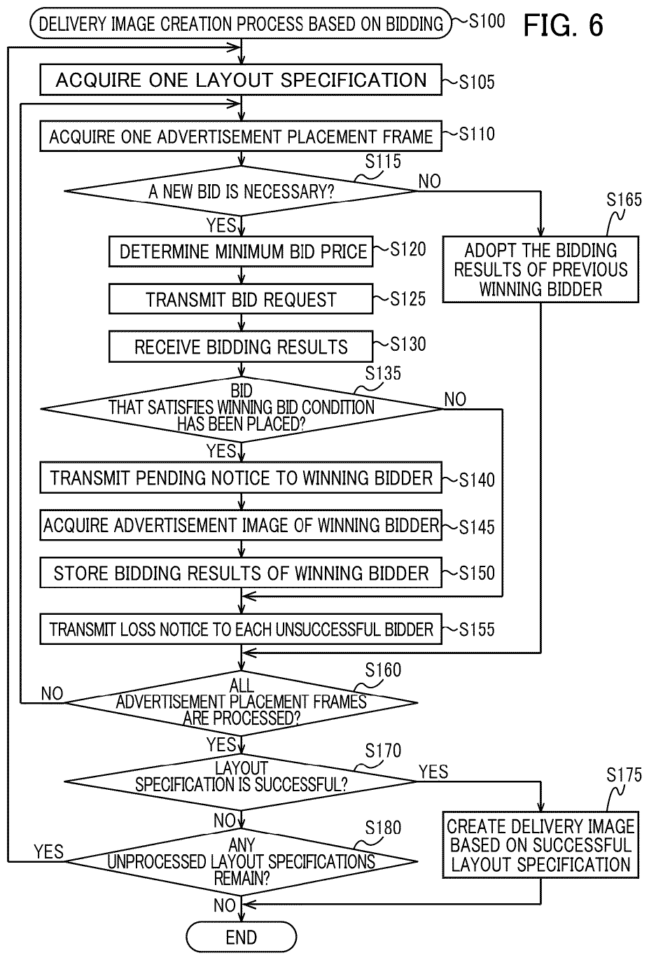

As described above, the advertisement placement frame A31 in the layout specification 3 is equivalent in size to each of the advertisement placement frames A21 and A22 in the layout specification 2. Therefore, when any bid for one of the advertisement placement frames A21 and A22 offered when bids are solicited with the layout specification 2 has a bid price greater than or equal to the minimum bid price, i.e., meets the condition for a winning bid in one of the plurality of advertisement placement frames (hereinafter simply called the “winning bid condition”), the advertisement image of the advertiser having the winning bid for this frame can be reassigned to the advertisement placement frame A31 in the layout specification 3. An example in which this reassignment technique is used to generate an image will be described later with reference to the flowchart in FIG. 6.

### <Layout Specification 4>

On the other hand, bidding in response to the bid solicitation with the layout specification 3 does not reach an all-frame bidding success state, bids are resolicited using a layout specification 4 shown in FIG. 3D. Bidding results that do not produce an all-frame bidding success state include cases in which no bids are received for any of the advertisement placement frames A31-A35, cases in which bids are received for some of the advertisement placement frames A31-A35 but not the rest, and cases in which bids are received for all of the advertisement placement frames A31-A35 but at least one of the bid prices is lower than the minimum bid price.

In the layout specification 4, eight advertisement placement frames A41, A42, A43, A44, A45, A46, A47, and A48 are arranged in the advertisement printing area. That is, the layout specification 3 defines the advertisement placement frames A41-A48. Each of these advertisement placement frames A41-A48 is equivalent in size to one division of the advertisement placement frame A11 in FIG. 3A when divided into eight equal parts or one division of either the advertisement placement frame A21 in FIG. 3B or A31 in FIG. 3C when divided into four equal parts. In this example, bids are solicited with the minimum bid price for each of the advertisement placement frames A41-A48 set to 12.5 yen.

When the bidding in response to the bid solicitation with the layout specification 4 reaches an all-frame bidding success state in which winning bids are received for all of the advertisement placement frames A41-A48 at a bid price that satisfies the minimum bid price, a delivery image having the advertisement images for winning advertisers placed in the corresponding advertisement placement frames A41-A48 is transmitted to the printer 200. Based on this delivery image, the printer 200 outputs, as the printed matter, one A4-size sheet with the eight advertisement images printed according to the layout specification 4.

As described above, each of the advertisement placement frames A41-A48 in the layout specification 4 is equivalent in size to the advertisement placement frames A32-A35 in the layout specification 3. Therefore, when any bid solicited for the layout specification 3 meets the winning bid condition for at least one of the advertisement placement frames A32-A35, the advertisement image of the advertiser having the winning bid for the frame may be reassigned to the delivery image formed based on the layout specification 4, as described above.

The advertisement placement frames A11, A21, A22, and A31-A35 shown in FIGS. 3A-3C are each an example of the first delivery frame. The advertisement placement frames A21, A22, A31-A35, and A41-A48 shown in FIGS. 3B-3D are each an example of the second delivery frame. The sizes of the advertisement placement frames A11, A21, A22, A31-A35, and A41-A48 are each an example of the frame size. The layout specifications 1, 2, 3, and 4 are an example of the plurality of pieces of layout information. The minimum bid prices of the advertisement placement frames A11, A21, A22, and A31-A35 are each an example of the first frame condition. The minimum bid prices of the advertisement placement frames A21, A22, A31-A35, and A41-A48 are each an example of the second frame condition.

The above layout specifications 1, 2, 3, and 4 provided with their respective advertisement placement frames A11, A21, A22, A31-A35, and A41-A48 are stored in the storage unit 115 of the advertisement provision server 100, for example. Further, the order in which sets of layout information are used when sequentially soliciting and resoliciting bids as described above, i.e., the order of the layout specification 1→the layout specification 2→the layout specification 3→the layout specification 4 used when soliciting bids for advertisement placement frames is preset and the contents of this setting are stored in the storage unit 115. In this case, the advertisement provision server 100 may acquire specification information on the printer 200 or information on the size of paper loaded in the paper tray of the printer 200, for example, and select a layout specification suitable for such information.

### <Resolicitation of Bids According to Another Example>

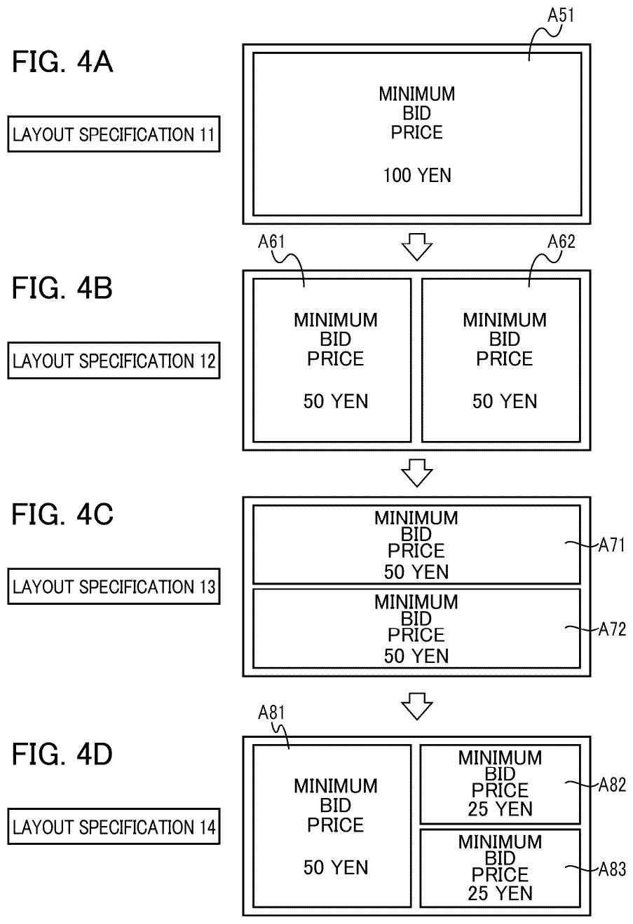

FIGS. 4A-4D illustrate another example of the process for resoliciting bids described above in FIGS. 3A-3D.

A layout specification 11 shown in FIG. 4A is identical to the layout specification 1 in FIG. 3A described above. One advertisement placement frame A51 identical to the advertisement placement frame A11 is set for a single advertisement printing area on an A4-size sheet and has a minimum bid price of 100 yen. That is, the layout specification 11 defines the advertisement placement frame A51.

When the bidding in response to the bid solicitation with the layout specification 11 does not result in an all-frame bidding success state, bids are resolicited using a layout specification 12 shown in FIG. 4B, which is the same layout as the layout specification 2 in FIG. 3B described above. In the layout specification 12, two advertisement placement frames A61 and A62 identical to the advertisement placement frames A21 and A22 described above are set for the advertisement printing area with a minimum bid price of 50 yen each. That is, the layout specification 11 defines the advertisement placement frames A61 and A62.

When the bidding in response to the bid solicitation with the layout specification 12 does not result in an all-frame bidding success state, bids are resolicited using a layout specification 13 shown in FIG. 4C. In layout specification 13, two advertisement placement frames A71 and A72 are set for the advertisement printing area described above. That is, the layout specification 11 defines the advertisement placement frames A71 and A72. The advertisement placement frames A71 and A72 are configured by dividing the advertisement placement frame A51 in FIG. 4A into two frames of equal size juxtaposed vertically and are each half the size of the advertisement placement frame A51. In this example, bids are solicited with the minimum bid price set at 50 yen for each of the advertisement placement frames A71 and A72, which is equivalent to the minimum bid price for the advertisement placement frames A61 and A62.

When the bidding in response to the bid solicitation with the layout specification 13 does not produce an all-frame bidding success state, bids are resolicited using a layout specification 14 shown in FIG. 4D. In the layout specification 14, one advertisement placement frame A81, which is of equal size to the advertisement placement frame A61 described above, and two advertisement placement frames A82 and A83 are set for the advertisement printing area described above. That is, the layout specification 11 defines the advertisement placement frames A81-A83. The advertisement placement frame A81 is equivalent in size to one division of the advertisement placement frame A51 in FIG. 4A when advertisement placement frame A51 is divided into two equal parts. The advertisement placement frames A82 and A83 are each equivalent in size to one division of the advertisement placement frame A62 shown in FIG. 4B when divided vertically into two equal parts, i.e., equivalent in size to one division of the advertisement placement frame A51 in FIG. 4A when divided into four equal parts. Therefore, when any bid for one of the advertisement placement frames A61 and A62 offered when bids are solicited with the layout specification 12 meets the condition for a winning bid, for example, the advertisement image of the advertiser having the winning bid may be reassigned to the advertisement placement frame A81 when generating a delivery image to be sent to the printer 200 based on the layout specification 14.

The advertisement placement frames A51, A61, A62, A71, and A72 shown in FIGS. 4A-4C are each an example of the first delivery frame. The advertisement placement frames A61, A62, A71, A72, and A81-A83 shown in FIGS. 4B-4D are each an example of the second delivery frame. The sizes of the advertisement placement frames A51, A61, A62, A71, A72, and A81-A83 are each an example of the frame size. The layout specifications 11, 12, 13, and 14 are an example of the plurality of pieces of layout information. The minimum bid prices of the advertisement placement frames A51, A61, A62, A71, and A72 are each an example of the first frame condition. The minimum bid prices of the advertisement placement frames A61, A62, A71, A72, and A81-A83 are each an example of the second frame condition.

The above layout specifications 11, 12, 13, and 14 provided with their respective advertisement placement frames A51, A61, A62, A71, A72, and A81-A83 are stored in the storage unit 115 of the advertisement provision server 100, for example. Further, the order in which sets of layout information are used when sequentially soliciting and resoliciting bids as described above, i.e., the order of the layout specification 11→the layout specification 12→the layout specification 13→the layout specification 14 used when soliciting bids for advertisement placement frames is preset, and the contents of this setting are stored in the storage unit 115.

### <Resolicitation of Bids According to Another Example>

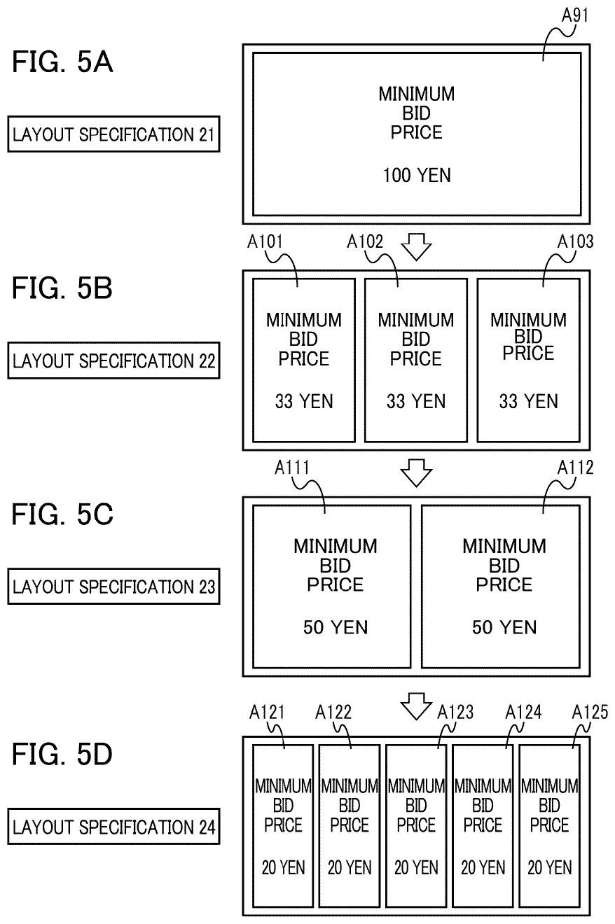

FIGS. 5A-5D illustrate yet another example of the above process for resoliciting bids.

A layout specification 21 shown in FIG. 5A is identical to the layout specification 1 of FIG. 3A and the layout specification 11 of FIG. 4A described above. A single advertisement placement frame A91 identical to each of the advertisement placement frames A11 and A51 is set for one advertisement printing area on an A4-size sheet and has a minimum bid price of 100 yen. That is, the layout specification 21 defines the advertisement placement frame A91.

When the bidding in response to the bid solicitation with the layout specification 21 does not result in an all-frame bidding success state, bids are resolicited using a layout specification 22 shown in FIG. 5B. In the layout specification 22, three advertisement placement frames A101, A102, and A103 are set for the advertisement printing area described above. That is, the layout specification 22 defines the advertisement placement frames A101-A103. The advertisement placement frames A101, A102, and A103 are configured by dividing the advertisement placement frame A91 in FIG. 5A into three equal parts juxtaposed in the left-right direction and are each one-third the size of the advertisement placement frame A91. In this case, bids are solicited with the minimum bid price of 33 yen for each of the advertisement placement frames A101, A102, and A103.

When the bidding in response to the bid solicitation with the layout specification 22 does not produce an all-frame bidding success state, bids are resolicited using a layout specification 23 shown in FIG. 5C. In the layout specification 23, two advertisement placement frames A111 and A112 are set for the advertisement printing area described above. That is, the layout specification 23 defines the advertisement placement frames A111 and A112. The advertisement placement frames A111 and A112 are configured by dividing the advertisement placement frame A91 in FIG. 5A into two equal parts juxtaposed in the left-right direction and are each one-half the size of the advertisement placement frame A91. In this case, bids are solicited with the minimum bid price set to 50 yen for each of the advertisement placement frames A111 and A112.

When the bidding in response to the bid solicitation using the layout specification 23 does not result in an all-frame bidding success state, bids are resolicited with a layout specification 24 shown in FIG. 5D. In the layout specification 24, five advertisement placement frames A121, A122, A123, A124, and A125 are set for the advertisement printing area described above. That is, the layout specification 24 defines the advertisement placement frames A121-A125. The advertisement placement frames A121-A125 are configured by dividing the advertisement placement frame A91 in FIG. 5A into five equal parts juxtaposed in the left-right direction and are each one-fifth the size of the advertisement placement frame A91. In this case, bids are solicited with the minimum bid price set to 20 yen for each of the advertisement placement frames A121, A122, A123, A124, and A125.

The advertisement placement frames A91, A101-A103, A111, and A112 shown in FIGS. 5A-5C are each an example of the first delivery frame. The advertisement placement frames A101-A103, A111, A112, and A121-A125 shown in FIGS. 5B-5D are each an example of the second delivery frame. The sizes of the advertisement placement frames A91, A101-A103, A111, A112, and A121-A125 are each an example of the frame size. The layout specifications 21, 22, 23, and 24 are an example of the plurality of pieces of layout information. The minimum bid prices of the advertisement placement frames A91, A101-A103, A111, and A112 are each an example of the first frame condition. The minimum bid prices of the advertisement placement frames A101-A103, A111, A112, and A121-A125 are each an example of the second frame condition.

The above layout specifications 21, 22, 23, and 24 provided with their respective advertisement placement frames A91, A101-A103, A111, A112, and A121-A125 are stored in the storage unit 115 of the advertisement provision server 100, for example. Further, the order in which sets of layout information are used when sequentially soliciting and resoliciting bids as described above, i.e., the order of the layout specification 21→the layout specification 22→the layout specification 23→the layout specification 24 used when soliciting bids for advertisement placement frames is preset, and the contents of this setting are stored in the storage unit 115. Hereinafter, advertisement placement frames will simply be called “advertisement placement frames A” when not distinguishing individual frames.

### <Image Creation Process on Advertisement Provision Server>

The control process executed by the control unit 110 of the advertisement provision server 100 in S100 described above will be described next with reference to the flowchart in FIG. 6. The image creation process in FIG. 6 is performed to implement the methods described above using FIGS. 3A-3D, FIGS. 4A-4D, and FIGS. 5A-5D as examples.

In S105 at the beginning of the process in FIG. 6, the control unit 110 selects and acquires one layout specification according to the preset order stored in the storage unit 115, as described above. The process executed in S105 is an example of the layout selection process.

Based on the content stored in the storage unit 115 in advance, in S110 the control unit 110 acquires one advertisement placement frame A according to a predetermined order from among one or more advertisement placement frames A provided in the layout specification acquired in S105.

In S115 the control unit 110 determines whether a new bid is necessary for the advertisement placement frame A acquired in S110. As described above, when bidding using a layout specification acquired in S105 previously executed does not result in an all-frame bid success state, any bids that meet the winning bid condition for at least one of the advertisement placement frames in this layout specification can be reassigned to the advertisement placement frames of the same size in the subsequent layout specification acquired in S105 next executed when bids are resolicited. When such a reassignment is possible for the current advertisement placement frame A, the control unit 110 determines that a new bid is not necessary for this frame (S115: NO) and advances to the process in S165 described later. When such a reassignment is not possible for the current advertisement placement frame A, the control unit 110 determines that a new bid is needed (S115: YES) and advances to the process in S120. On the other hand, when bidding is solicited using a subsequent layout specification due to bidding with the previous layout specification not producing an all-frame bidding success state, the control unit 110 need not perform such a reassignment but may always solicit new bids. In this case, the process of S115 would be omitted, and the control unit 110 would simply advance to S120 described below after completing the process of S110.

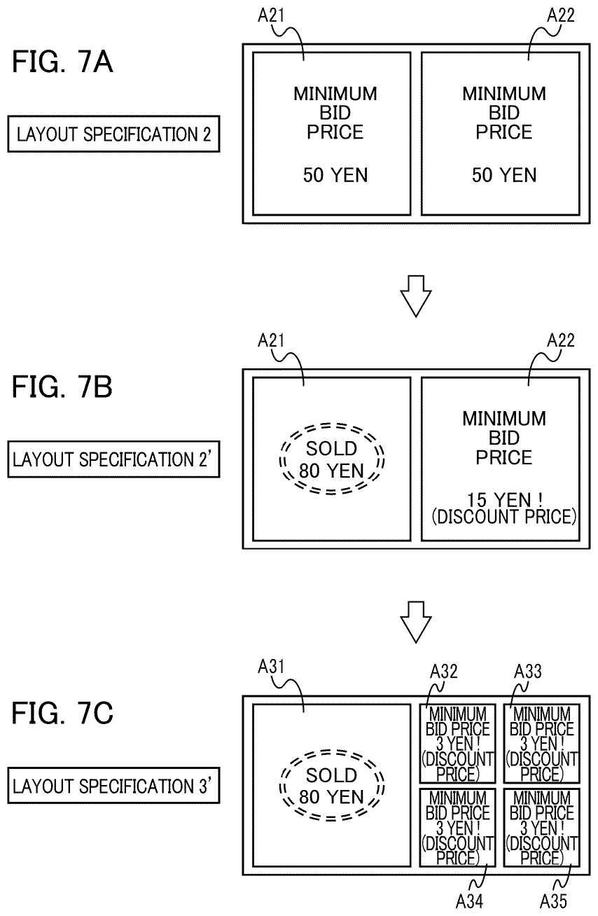

In S120 the control unit 110 determines the corresponding minimum bid price for the advertisement placement frame A acquired in S110. In the present embodiment, the minimum bid price for each advertisement placement frame A is uniquely determined in advance and stored in the storage unit 115, as described above, unlike in a variation described later with reference to FIG. 7. In S120 the control unit 110 determines the corresponding minimum bid price based on this content stored in the storage unit 115.

In S125 the control unit 110 transmits a bid request to the advertisement management server 500 for the single advertisement placement frame A acquired in S110. At this time, information on the size of the advertisement placement frame A, the minimum bid price determined in S120, and the user interest information acquired in S25 of FIG. 2 are transmitted together with the bid request as predetermined conditions requested by this bid request. In response to this bid request, the advertisement management server 500 holds an auction to solicit bids for an advertisement tailored to the user interest information received from the advertisement provision server 100. The process executed in S125 is an example of the first request process and is also an example of the second request process.

Note that the bid request sent to the advertisement management server 500 in S125 may include size information, user information, and the like without specifying a minimum bid price. Alternatively, the bid request may be issued using fixed values.

In S130 the control unit 110 receives, from the advertisement management server 500, bidding results of the auction held in response to the bid request sent in S125. When one or more bids that satisfy the predetermined conditions requested by the bid request have been placed, the content of the received bidding results include a message to that effect and one or more advertisement images of one or more bidders corresponding the one or more bids that satisfy the predetermined conditions. However, when no bids that satisfy the predetermined conditions requested by the bid request have been placed, a message to that effect is included in the content of the bidding results. Note that, when placing a bid for the advertisement placement frame A in the auction, a bidder designates an advertisement image that the bidder desires to place in that advertisement placement frame A. Therefore, each of the advertisement images included in the content of the bidding results received in S130 is information (an image) designated, as the subject of the advertisement delivery service, in association with the submission of the corresponding bid. The one or more advertisement images received in S130 are an example of the one or more pieces of first information and are also an example of the one or more pieces of second information. The process executed in S130 is an example of first information acquisition process and is also an example of the second information acquisition process.

In S135 the control unit 110 determines based on the content received in S130 whether a bid that satisfies the winning bid condition has been placed. In other words, in S135 the control unit 110 determines based on the content received in S130 whether the advertisement placement frame A acquired in S110 has received a bid satisfying the winning bid condition, i.e., whether an advertisement image is placeable in the advertisement placement frame A acquired in S110. The winning bid condition is the bid price is the highest, for example. The winning bid condition may be that the predetermined conditions requested by the bid request are satisfied. When there is no bid that satisfies the winning bid condition (i.e., that no advertisement image can be placed in the advertisement placement frame A acquired in S110) (S135: NO), the control unit 110 advances to the process in S155 described later. However, when there is a bid that satisfies the winning bid condition (i.e., that an advertisement image can be placed in the advertisement placement frame A acquired in S110) (S135: YES), the control unit 110 advances to S140.

In S140 the advertisement provision server 100 sends a “pending notice” to the advertisement management server 500 in order to notify the winning bidder (i.e., the advertiser who has submitted the bid satisfying the winning bid condition) that the content of the bid has been adopted and will be stored without deletion. Upon receiving this pending notice, the advertisement management server 500 transfers the pending notice to the terminal device or the like of the winning bidder.

In S145 the control unit 110 identifies and acquires the advertisement image of the winning bidder. The advertisement image of the winning bidder is included in the bidding results received from the advertisement management server 500 in S130. In S150 the control unit 110 stores the bidding results by the winning bidder, i.e., the advertisement image acquired in S145 and the like in the storage unit 115.

In S155 the control unit 110 transmits a loss notice to the advertisement management server 500 to notify unsuccessful bidders, i.e., advertisers who have submitted bids not meeting the winning bidder condition, that their bidding content have not been adopted because another bidder has had the winning bid. Upon receiving this loss notice, the advertisement management server 500 transfers the notice to the terminal devices or the like of the unsuccessful bidders. Subsequently, the process advances to S160.

In S160 the control unit 110 determines whether the process described above has been performed for each of the one or more advertisement placement frames A included in the layout specification acquired in S105. When all of the one or more advertisement placement frames A included in the above layout specification have been processed (S160: YES), the control unit 110 advances to S170 described later.

However, when any unprocessed advertisement placement frame A remains in the above layout specification (S160: NO), the control unit 110 returns to S110 and repeats the same process described above. That is, in S110 the control unit 110 acquires a new advertisement placement frame A, which is the next in sequence following the advertisement placement frame A most recently processed in S110-S155, and in S115 determines whether a new bid is required for this new advertisement placement frame A. Here, when bidding results containing the advertisement image of a winning bidder are saved in the process of S150 performed with respect to any of the advertisement placement frames A of the layout specifications processed prior to the current layout specification, in S115 the control unit 110 may be able to reassign the saved advertisement image, as described above. When reassignment is not possible, the control unit 110 determines that a new bid is needed (S115: YES). In this case, the control unit 110 sends a loss notice for the winning bidder of the deleted advertisement image to the advertisement management server 500. Note that, when determining that the saved advertisement image (i.e., the advertisement image saved in S150 executed for the previous layout specification) cannot be reassigned to any of the advertisement placement frames A included in the current layout specification, the control unit 110 deletes that saved advertisement image. For example, the control unit 110 may perform this process after determining in S160 that all of the advertisement placement frames A included in the current layout specification have been processed. On the other hand, when reassignment is possible, the control unit 110 determines that a new bid is not needed (S115: NO) and advances to S165. In S165 the control unit 110 adopts the bidding results containing the advertisement image of the winning bidder that has been saved in S150. In other words, the control unit 110 determines that the saved advertisement image of this winning bidder is to be placed in the new advertisement placement frame A. Subsequently, the control unit 110 advances to S160 to perform the determination described above. The process of S165 is an example of the determination process.

The control unit 110 repeats the process in S110-S160 as described above while not all advertisement placement frames A in the layout specification acquired in S105 have been processed. When the control unit 110 determines that all advertisement placement frames A included in this layout specification have been processed (S160: YES), the control unit 110 advances to S170.

In S170 the control unit 110 determines whether bids satisfying the winning bid condition have been received for all advertisement placement frames A in the layout specification obtained in S105 so that the layout specification is successful. In other words, the control unit 110 determines whether a delivery image based on this layout specification can be sent to the printer 200. When the layout specification is successful (S170: YES), the control unit 110 advances to S175.

In S175 the control unit 110 creates a delivery image using the content of the successful layout specification. In other words, the control unit 110 creates a delivery image in which all of the advertisement placement frames A are arranged according to this layout specification and the advertisement images of the corresponding winning bidders are placed in all of the advertisement placement frames A included in this layout specification (i.e., creates a delivery image in which all of the advertisement placement frames A defined by this layout specification are arranged according to the layout specification and each of all of the advertisement placement frames A has the corresponding advertisement image placed therein). Subsequently, the control unit 110 ends the process of FIG. 6. Note that rather than creating a delivery image in S175, the control unit 110 may create data for printing a delivery image in any of various page description languages.

On the other hand, when the control unit 110 determines in S170 that the layout specification acquired in S105 is not successful (S170: NO), the control unit 110 advances to S180. In S180 the control unit 110 determines according to the preset order described above whether any unprocessed layout specifications remain. When all layout specifications have been processed according to the preset order (S180: NO), the control unit 110 ends the process in FIG. 6. Since the process ends without finding any successful layout specification, steps S30, S35, S40, and S45 of FIG. 2 are not executed. Further, in S50 of FIG. 2 the control unit 110 stores in the storage unit 115: information indicating that a delivery image has not been sent to the printer 200; the printer ID of the corresponding printer 200; the external user ID of the corresponding user; and the current time information in association with each other. Subsequently, the control unit 110 ends the control sequence of FIG. 2.

However, when the control unit 110 determines in S180 that an unprocessed layout specification remains (S180: YES), the control unit 110 returns to S105 and repeats the above process on the next layout specification. That is, in S105 the control unit 110 acquires a new layout specification, which is the next specification in the predetermined order, repeats the process in S110-S160 on this new layout specification, and in S170 determines whether the layout specification is successful. When successful, the control unit 110 creates a delivery image in S175. When not successful, the control unit 110 repeats the process in S110-S180 until no more layout specifications remain to be processed (S180: NO). In this way, using the example shown in FIGS. 3A-3D described above, the control unit 110 sequentially attempts to make a layout specification successful in the order layout specification 1→layout specification 2→layout specification 3→layout specification 4.

### <Layout Specification 1→Layout Specification 2>

After first performing the process in S105-S180 for the layout specification 1, the control unit 110 repeats the process in S105-S108 for the layout specification 2. In this case, the layout specification 1 is an example of the first piece of layout information, and the advertisement placement frame A11 included in the layout specification 1 is an example of the one or more first delivery frames. Further, the frame size, minimum bid price, and the like of the advertisement placement frame A11 are each an example of the first frame condition, and the process executed in S125 is an example of the first request process. Further, the advertisement images included in the content received in S130 in response to this request in S125 are an example of the at least one piece of first information, and the process executed in S130 is an example of the first information acquisition process. Further, the processes executed in S170 in response to processes related to the layout specification 1 described above is an example of the first determination process, the process of S175 executed in response to a YES determination being made in S170 for the layout specification 1 is an example of the first creation process, and the delivery image created in S175 is an example of the first delivery information. In a case where a YES determination is made in S135 and bidding results for one of the advertisement placement frames A in the layout specification 1 are saved in S150, the process of S150 is an example of the information saving process.

Further, the layout specification 2 is an example of the second piece of layout information, and the advertisement placement frames A21 and A22 included in the layout specification 2 are an example of the one or more second delivery frames. As a result, the number of the advertisement placement frames A as the second delivery frames in the layout specification 2 is greater than the number of the advertisement placement frames A as the first delivery frames in the layout specification 1. Further, the frame size of the advertisement placement frame A11 in the layout specification 1 is n times (where n is an integer of 2 or greater) each of the advertisement placement frames A21 and A22 in the layout specification 2. In this example, n=2.

The frame size, minimum bid price, and the like for each of the advertisement placement frames A21 and A22 are each an example of the second frame condition, and the process executed in S125 is an example of the second request process. Further, the advertisement images included in the content received in S130 in response to this request in S125 are an example of the at least one piece of second information, and the process executed in S130 is an example of the second information acquisition process. Further, the processes executed in S170 in response to processes related to the layout specification 2 are performed to determine, for each of the advertisement placement frames A21 and A22, whether at least one of a piece of first information related to the layout specification 1 and a piece of second information related to the layout specification 2 is placeable in the advertisement placement frame A from among the one or more pieces of first information acquired for the layout specification 1 and the at least one piece of second information acquired for that advertisement placement frame A. S170 in this case is an example of the second determination process. The process of S175 executed in response to a YES determination being made in S170 for the layout specification 2 is an example of the second creation process.

### <Layout Specification 2→Layout Specification 3>

When the layout specification 2 is also not successful in the above process, after the control unit 110 performs the process in S105-S180 for the layout specification 2, the control unit 110 repeats the process in S105-S180 for the layout specification 3. In this case, the layout specification 2 is an example of the first piece of layout information, and the advertisement placement frames A21 and A22 included in the layout specification 2 are an example of the one or more first delivery frames. Further, the frame size, minimum bid price, and the like for the advertisement placement frames A21 and A22 are each an example of the first frame condition, and the process executed in S125 is an example of the first request process. Further, the advertisement images included in the content received in S130 in response to this request in S125 is an example of the at least one piece of first information, and the process executed in S130 is an example of the first information acquisition process. Further, the processes executed in S170 in response to processes related to the layout specification 2 described above are an example of the first determination process, the process of S175 executed in response to a YES determination being made in S170 for the layout specification 2 is an example of the first creation process, and the delivery image created in S175 is an example of the first delivery information. In a case where a YES determination is made in S135 and bidding results for one of the advertisement placement frames A in the layout specification 2 are saved in S150, the process of S150 is an example of the information saving process.

The layout specification 3 is an example of the second piece of layout information, and the advertisement placement frames A31-A35 included in the layout specification 3 are examples of the one or more second delivery frames. As a result, the number of the advertisement placement frames A as the second delivery frames in the layout specification 3 is greater than the number of the advertisement placement frames A as the first delivery frames in the layout specification 2. Further, the frame size of each of the advertisement placement frames A21 and A22 in the layout specification 2 is n times (where n is an integer of 2 or greater) each of the advertisement placement frames A32-A35 in the layout specification 3. In this example, n=4. Further, at least one advertisement placement frame A as the second delivery frame in the layout specification 3 as the second piece of layout information (the advertisement placement frame A31 in this example) has the same frame size as the advertisement placement frames A21 and A22 as the first delivery frames in the layout specification 2 as the first piece of layout information.

The frame size, minimum bid price, and the like for each of the advertisement placement frames A31-A35 are each an example of the second frame condition, and the process executed in S125 is an example of the second request process. Further, the advertisement images included in the content received in S130 in response to this request in S125 are an example of the at least one piece of second information, and the process executed in S130 is an example of the second information acquisition process. Further, the processes executed in S170 in response to processes related to layout specification 3 described above is performed to determine, for all of each of the advertisement placement frames A31-A35, whether at least one of a piece of first information related to the layout specification 2 and a piece of second information related to the layout specification 3 is placed in the advertisement placement frame A from among the one or more pieces of first information acquired for the layout specification 2 and the at least one piece of second information acquired for that advertisement placement frame A. S170 in this case is an example of the second determination process. When a piece of first information has been saved for the advertisement placement frame A21 or the advertisement placement frames A22 in S150 in the process related to the layout specification 2, the control unit 110 determines in S170 whether this piece of first information is placeable in at least one of the advertisement placement frames A31-A35 that are the second delivery frames. The process of S175 executed in response to a YES determination being made in S170 for the layout specification 3 is an example of the second creation process. When the control unit 110 determines in S170 that the first information is placeable in at least one of the advertisement placement frames A31-A35, in S175 a delivery image is created in which both the piece of first information and pieces of second information related to the layout specifications 2 and 3 are placed in accordance with the layout specification 3. This delivery image is an example of the second delivery information.

### <Layout Specification 3→Layout Specification 4>

When the layout specification 3 is also not successful in the above process, after the control unit 110 performs the process in S105-S180 for the layout specification 3, the control unit 110 repeats the process in S105-S108 for the layout specification 4. In this case, the layout specification 3 is an example of the first piece of layout information, and the advertisement placement frames A31-A35 included in the layout specification 3 are an example of the one or more first delivery frames. Further, the frame size, minimum bid price, and the like for the advertisement placement frames A31-A35 are each an example of the first frame condition, and the process executed in S125 is an example of the first request process. Further, the advertisement images included in the content received in S130 in response to this request in S125 is an example of the at least one piece of first information, and the process executed in S130 is an example of the first information acquisition process. Further, the processes executed in S170 in response to processes related to the layout specification 3 described above are an example of the first determination process, the process of S175 executed in response to a YES determination being made in S170 for the layout specification 3 is an example of the first creation process, and the delivery image created in S175 is an example of the first delivery information. In a case where a YES determination is made in S135 and bidding results for one of the advertisement placement frames A in the layout specification 3 is saved in S150, the process of S150 is an example of the information saving process.

The layout specification 4 is an example of the second piece of layout information, and the advertisement placement frames A41-A48 included in the layout specification 4 are an example of the one or more second delivery frames. As a result, the number of the advertisement placement frames A as the second delivery frames in the layout specification 4 is greater than the number of the advertisement placement frames A as the first delivery frames in the layout specification 3. Further, the frame size of the advertisement placement frame A31 in the layout specification 3 is n times (where n is an integer of 2 or greater) each of the advertisement placement frames A41-A48 in the layout specification 4. In this example, n=4. Further, at least one advertisement placement frame A as the second delivery frame in the layout specification 4 as the second piece of layout information (the advertisement placement frames A41-A48 in this example) has the same frame size as the advertisement placement frames A32-A35 as the first delivery frames in the layout specification 3 as the first piece of layout information.

The frame size, minimum bid price, and the like for each of the advertisement placement frames A41-A48 are each an example of the second frame condition, and the process executed in S125 is an example of the second request process. Further, the advertisement images included in the content received in S130 in response to this request in S125 is an example of the at least one piece of second information, and the process executed in S130 is an example of the second information acquisition process. Further, the processes executed in S170 in response to processes related to layout specification 4 described above is performed to determine, for all of each of the advertisement placement frames A41-A48, whether at least one of a piece of first information related to the layout specification 3 and a piece of second information related to the layout specification 4 is placeable in the advertisement placement frame A from among the one or more pieces of first information acquired for the layout specification 3 and the at least one piece of second information acquired for that advertisement placement frame A. S170 in this case is an example of the second determination process. When a piece of first information has been saved for at least one of the advertisement placement frames A32-A35 in S150 in the process related to the layout specification 3, the control unit 110 determines in S170 whether this piece of first information is placeable in at least one of the advertisement placement frames A41-A48 that are the second delivery frames. The process of S175 executed in response to a YES determination being made in S170 for the layout specification 4 is an example of the second creation process. When the control unit 110 determines in S170 that a piece of first information is placeable in at least one of the advertisement placement frames A41-A48, in S175 the control unit 110 creates a delivery image in which both the piece of first information and pieces of second information related to the layout specifications 3 and 4 are placed in accordance with the layout specification 4. This delivery image is an example of the second delivery information.

The above example describes the pieces of first and second information, first and second request processes, first and second information acquisition processes, first and second determination processes, first and second delivery information, first and second creation processes, and the like using the example in which the processes are performed in the sequence of the layout specifications 1→2→3→4 shown in FIGS. 3A-3D. However, similar relationships to those described above are established even when attempting to make a layout specification successful in the sequence of the layout specifications 11→12→13→14 shown in FIGS. 4A-4D and in the sequence of the layout specifications 21→22→23→24 shown in FIGS. 5A-5D.

### <Processes Following the Image Creation Process>

Returning to FIG. 2, after the advertisement provision server 100 completes the process of S100 as described above, the process advances to S30. In S30 the advertisement provision server 100 transmits to the printer 200 a print instruction instructing to print the delivery image. The print instruction includes the delivery image created in S175 of the delivery image creation process of S100. The printer 200 receives the print instruction from the advertisement provision server 100 in S35 and generates printed matter by printing the delivery image included in the print instruction. That is, in S30 the advertisement provision server 100 provides the delivery image created in S175, and in S35 the printer 200 receives the delivery image created in S175 and prints an image based on the received delivery image on a sheet of printing paper. The advertisement provision server 100 may also deliver the delivery image to the printer 200 through a relay device in S30. Alternatively, instead of delivering the delivery image to the printer 200, the advertisement provision server 100 may transmit data for printing the delivery image in a page description language or a link to the delivery image to the printer 200. When the printer 200 receives the link to the delivery image, the printer 200 accesses that link to acquire the delivery image and prints the acquired delivery image. The process of S30 is an example of the information provision process.

In S40 the advertisement provision server 100 transmits a billing notification to the advertisement management server 500 in order that the advertisement management server 500 can bill each advertiser (i.e., each winning bidder that has provided the advertisement image included in the delivery image sent in S30) the corresponding fee for printing the advertisement. Upon receiving the billing notice from the advertisement provision server 100, in S45 the advertisement management server 500 performs a billing process to send a billing notification to the terminal device or the like of each winning bidder. Note that the processes in S40 and S45 to send the billing notification and execute the billing process may be performed only after it is confirmed that the printed matter has been successfully generated in S30. In this case, if the printed matter has not been generated properly on the printer 200, the billing process may not be performed at all, and if billed charges have been already settled, the full amount of this settlement may be refunded.

In S50 the advertisement provision server 100 stores the delivery image sent in S30 in the storage unit 115 in association with the printer ID of the corresponding printer 200, the external user ID of the corresponding user, the current time information, and the winning bid condition met by the bid of the winning bidder of each advertisement image included in the delivery image. Subsequently, the process according to the sequence chart in FIG. 2 ends.

### Effects of the Embodiment

In the above embodiment, the control unit 110 of the advertisement provision server 100 transmits bid requests to the advertisement management server 500 in S125 and receives bidding results in S130 in response to this request. Based on the content of the bidding results, the control unit 110 determines in S170 whether advertisement images satisfying the winning bid conditions can be placed in all the advertisement placement frames A in the layout specification (i.e., whether all the advertisement placement frames A in the layout specification each have received a bid satisfying the winning bid condition). When the control unit 110 determines that advertisement images satisfying the winning bid conditions can be placed in all advertisement placement frames A (i.e., that all of the advertisement placement frames A in the layout specification each have received a bid satisfying the winning bid condition), in S175 the control unit 110 creates a delivery image in which these advertisement images are arranged according to the layout specification. However, when the control unit 110 determines in S170 that no advertisement images satisfying the winning bid condition can be placed in at least one of the advertisement placement frames A (i.e., that not all of the advertisement placement frames A each have received a bid satisfying the winning bid condition), in S105 the control unit 110 acquires a different layout specification and transmits a new bid request to the advertisement management server 500 for the advertisement placement frames A in this new layout specification.

According to this embodiment, when advertisement images satisfying the winning bid conditions cannot be arranged according to one layout specification, the control unit 110 acquires bidding results from the advertisement management server 500 in response to a bid request for arranging advertisement images according to a different layout specification. According to this embodiment, the control unit 110 attempts to make a layout specification successful while dynamically changing the layout specifications until a layout specification is successful, i.e., until finding a layout specification in which all advertisement placement frames A are awarded winning bids. Therefore, compared to a configuration in which advertisement information is arranged based on a predetermined fixed layout, the method of this embodiment can further increase the flexibility in laying out advertisement information and can provide advertisement information in a wider variety of layouts.

A particular feature of this embodiment is that when the advertisement provision server 100 cannot arrange advertisement images that meet the winning bid conditions according to one layout specification, in S130 the advertisement provision server 100 receives bidding results for a bid request for arranging advertisement images according to a different layout specification. Based on the received bidding results, the advertisement provision server 100 determines in S170 whether advertisement images meeting the winning bid conditions can be placed in all advertisement placement frames A of the different layout specification. When such an arrangement is determined to be possible for all advertisement placement frames A, in S175 the advertisement provision server 100 creates a delivery image in which the advertisement images satisfying the winning bid conditions are arranged according to this different layout specification.

According to this embodiment, advertisement information can be reliably provided in a variety of layouts, unlike a configuration in which advertisement images are arranged based on a fixed layout determined in advance.

Even when no advertisement image satisfying the winning bid condition cannot be placed in at least one of advertisement placement frames A according to one layout specification, there may be a case where at least one advertisement image satisfying the winning bid condition can be placed in at least one of these advertisement placement frames A. A particular feature of this embodiment is that when the advertisement provision server 100 determines in S135 while repeating the process in S110-S170 that at least one advertisement image satisfying the winning bid condition can be placed in at least one of the advertisement placement frames A, in S150 the advertisement provision server 100 saves the at least one advertisement image satisfying the winning bid condition in the storage unit 115.

According to this embodiment, the advertisement image saved in the storage unit 115 as described above when attempting to place advertisement images according to one layout specification can be utilized when arranging advertisement images according to a different layout specification attempted next in order after the one layout specification.

Another feature of this embodiment is that partial commonality may exist between one layout specification and a different layout specification attempted next in order after the one layout specification, as in the example of the layout specifications 2 and 3 and the layout specifications 3 and 4. According to this embodiment, the advertisement image stored in the storage unit 115 that satisfies the winning bid condition in one layout specification can be reliably utilized when arranging advertisement images according to a different layout specification.

Another feature of the present embodiment is that when attempting to make successful a different layout specification that is next in order after one layout specification is not successful, in S115 the advertisement provision server 100 determines whether an advertisement image saved in S150 can be utilized in accordance with this different layout specification. When determining that the advertisement image can be utilized, the advertisement provision server 100 can reliably arrange both the advertisement image saved in S150 and advertisement images that satisfy the winning bid conditions based on the different layout specification in advertisement placement frames A according to the different specification.

Another feature of the present embodiment is that when the advertisement provision server 100 determines that an advertisement image saved in S150 can be utilized when attempting to make a different layout specification successful, the advertisement provision server 100 can generate a delivery image in which both this saved advertisement image and the advertisement images satisfying the winning bid conditions based on the different layout specification are placed in the corresponding advertisement placement frames A in accordance with this different layout specification.

Another feature of the present embodiment is that when one layout specification is not successful and thus the advertisement provision server 100 attempts to make successful a different layout specification following this one specification in order, the number of the advertisement placement frames A in the different layout specification may be greater than the number of the advertisement placement frames A in the one layout specification (see FIGS. 3A-3D, FIGS. 4A-4B, FIGS. 4C-4D, FIGS. 5A-5B, and FIGS. 5C-5D). In this case, the advertisement provision server 100 can sequentially examine a plurality of layout specifications whose number of the corresponding advertisement placement frames A increases sequentially to determine whether the advertisement images satisfying the winning bid conditions can be placed.

According to this embodiment, the advertisement provision server 100 can perform a process to create a delivery image based on the layout specification having as few advertisement placement frames A as possible.

Another feature of this embodiment is that when one layout specification is not successful and thus the advertisement provision server 100 attempts to make successful a different layout specification that is next in order, the frame size of at least one of the advertisement placement frames A in the one layout specification may be n times (where n is an integer of 2 or greater) the frame size of at least one of the advertisement placement frames A in the different layout specification (see FIGS. 3A-3D, 4A-4B, 4C-4D, and 5A-5B). In this case, the advertisement provision server 100 can sequentially examine a plurality of layout specifications in which the frame size of the corresponding advertisement placement frames A have been divided into 1/n increments to determine whether advertisement images satisfying the winning bid conditions can be placed.

According to this embodiment, the advertisement provision server 100 can perform a process to create a delivery image based on the layout specification having as few advertisement placement frames A as possible. Additionally, the frame size of one advertisement placement frame A in the different layout specification is 1/n the frame size of one advertisement placement frame A in the one layout specification. As a result, when arranging advertisement images according to the different layout specification, the advertisement provision server 100 can fill an area having a size equivalent to one advertisement placement frame A in the one layout specification with n advertisement placement frames A corresponding to the different layout specification.

Another feature of this embodiment is that in a system configured with a printer 200 for printing delivery images on printing paper, the system can further increase flexibility in the printing layout for advertisement information and can print advertisement information in a wider variety of layouts, compared to a configuration in which advertisement information is printed according to a fixed print layout determined in advance.

While the invention has been described in conjunction with the example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below, wherein like parts and components to those in the above embodiment are designated with the same reference numerals to avoid duplicating description. Further, the present disclosure includes the phrases “at least one of A and B”, “at least one of A, B and C”, “at least one of A, B, C and D”, and the like as alternative expressions that mean one or more of A and B, one or more of A, B and C, one or more of A, B, C and D, and the like, respectively. For example, the phrase “at least one of A, B and C” means (A), (B), (C), (A and B), (A and C), (B and C) or (A, B and C).

(1) A Case in which the Minimum Bid Price for Advertisement Placement Frames is Dynamically Changed

Based on the winning bid results for some advertisement placement frames A, the minimum bid price for the remaining advertisement placement frames A may be changed dynamically. A variation of this type will be described with reference to FIG. 7.

FIGS. 7A-7C, which correspond to FIGS. 3B-3C described above, show a process flow for resoliciting bids in the present variation. As in FIG. 3A described above, the present variation begins with bid solicitation using the layout specification 1 in which one advertisement placement frame A11 has been set for one advertisement printing area, which corresponds to nearly an entire A4-size sheet of paper (not shown). When the layout specification 1 is not successful, bids are resolicited with the layout specification 2 shown in FIG. 7A, which is identical to FIG. 3B.

As in FIG. 3B, in the layout specification 2, the two advertisement placement frames A21 and A22, which are each half the frame size of the advertisement placement frame A11. Bids are then solicited with the minimum bid price set to 50 yen for each of the advertisement placement frames A21 and A22.

Now, suppose that the cost to produce a single printed matter including the cost of ink required to print the advertisement printing area of an A4-size sheet (i.e., the break-even point), for example, is 60 yen. When soliciting bids according to the layout specification 2 in this case, one of the advertisement placement frames A, such as the advertisement placement frame A21, may receive a winning bid at 80 yen, as indicated in FIG. 7B, which is higher than the break-even point. In this case, the advertisement provision server 100 in the present variation dynamically modifies the minimum bid price for any advertisement placement frames that have not been awarded a successful bid, as illustrated in the layout specification 2′ of FIG. 7B. In this example, the minimum bid price for the advertisement placement frame A22 has been lowered from 50 yen shown in FIG. 7A to 15 yen.

When there is still no winning bid for the advertisement placement frame A22 when resoliciting bids with the layout specification 2′ or when there are bids but the bids are less than 15 yen, bids are resolicited using the layout specification 3′ corresponding to the layout specification 3 in FIG. 3C described above.

In the layout specification 3′ shown in FIG. 7C, as in the layout specification 3 of FIG. 3C, the advertisement placement frame A31, which is of equal size to the advertisement placement frames A21 and A22, and the four advertisement placement frames A32, A33, A34, and A35 are set for the advertisement printing area. In accordance with the winning bid of 80 yen for the advertisement placement frame A31 described above, bids are resolicited in this example with the minimum bid price for the advertisement placement frames A32, A33, A34, and A35 reduced to 3 yen.

Since the service provider's profit is already secured by the winning bid awarded for one advertisement placement frame A, a portion of the profits that is subsequently anticipated can be returned to the user side, i.e., the users of the service by reducing the minimum bid price for the other advertisement placement frames A.

In the above example, the minimum bid price for the advertisement placement frame A22 is set at 50 yen originally but is subsequently reduced to a fixed price of 15 yen after the advertisement placement frame A21 received a winning bid of 80 yen, which is above the break-even point for creating the printed matter, but the disclosure is not limited to this method. For example, the total amount of minimum bid prices for all advertisement placement frames A other than the advertisement placement frame A receiving the winning bid may be discounted by an amount equivalent to the difference between the winning bid price and the break-even point. In this case, when there is a plurality of remaining advertisement placement frames A that have not received a winning bid, the amount of discount equivalent to this difference can be divided equally among these remaining advertisement placement frames A. In the above example, this difference is 20 yen since the winning bid price for the advertisement placement frame A21 is 80 yen and the break-even point is 60 yen. Therefore, the minimum bid price for the advertisement placement frame A22 in layout specification 2′ is set to 30 yen, which is a discount of 20 yen from the original 50 yen. In the layout specification 3′, the minimum bid price for each of the advertisement placement frames A32, A33, A34, and A35 is set to 7.5 yen, which is a discount of 5 yen from the original 12.5 yen, making a total discount of 20 yen from the total amount of the minimum bid prices for all of the advertisement placement frames A32-A35.

The disclosure is not limited to the above-described method of reducing the minimum bid prices for advertisement placement frames A in the remaining portion of the advertisement printing area when at least one advertisement placement frame A arranged in the advertisement printing area has received a winning bid at a price exceeding the break-even point. In other words, instead of resoliciting bids at a fee for the remaining advertisement placement frames A, this space may be used as the service provider's own advertising space or may be used as a space for printing simple patterns or other designs rather than advertisements. By setting advertisement placement frames A other than those advertisement placement frames A that have received winning bids as a non-commercial area, the advertisement provision server 100 can quickly make the layout specification successful without waiting to receive bids for the other advertisement placement frames A. This method can avoid making the winning bidders wait longer than necessary and reliably avoid lost profits caused by the layout specification not being successful.

The present disclosure is also not limited to the above method of dynamically reducing the minimum bid prices of remaining advertisement placement frames A when the total winning bid price for some advertisement placement frames A is more than the break-even point, i.e., is greater than the cost of creating one printed matter, including the cost of ink for printing. Conversely, when advertisement placement frames A in the layout specification are not attracting winning bids at the currently set minimum bid price, the minimum bid prices may be dynamically dumped as needed, no matter where the break-even point is, i.e., without regard for profitability.

### (2) When Delivery Frames are Set as Time Frames

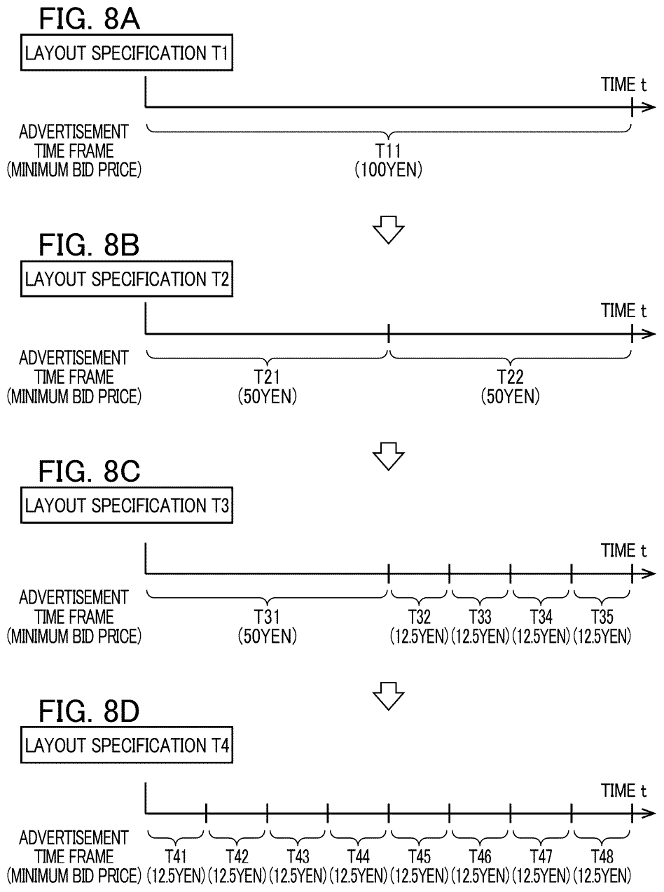

In the embodiment described above, advertisement placement frames A having predetermined sizes are set for the advertisement printing area on a sheet of printing paper to be printed when creating one sheet of printed matter and bids are solicited with minimum bid prices set according to the size of each advertisement placement frame A. In this variation, time-segment frames are set for visual or audible notifications outputted through displays, sound, or the like on a notification device different from the printer 200, and bids are solicited with minimum bid prices set according to the length of the time segment. An example of the process flow for resoliciting bids in this variation during a deliverable creation process, which corresponds to the above delivery image creation process of S100, will be described with reference to FIGS. 8A-8D, which correspond to FIGS. 3A-3D in the above embodiment.

### <Layout Specification T1>

The example shown in FIG. 8A represents a layout specification T1 used when bids are solicited for a layout having a single advertisement time frame T11 for one advertising time slot of a predetermined time length. In this example, bids are solicited with the minimum bid price set at 100 yen for the advertisement time frame T11. When the advertisement time frame T11 receives a winning bid of 100 yen or higher during bidding with the layout specification T1, the deliverable of the advertiser with the winning bid for the advertisement time frame T11, such as an advertisement image or sound, is sent to the notification device, which produces a visual or audible notification based on the layout specification T1.

### <Layout Specification T2>

When bidding using the layout specification T1 shown in FIG. 8A is unsuccessful, i.e., when no bids have been received or when bids have been received but are all under 100 yen, bids are subsequently resolicited using the layout specification T2 shown in FIG. 8B. In other words, in the layout specification T2, two advertisement time frames T21 and T22 having the same time length are set for the advertising time slot. The advertisement time frames T21 and T22 are set in this order by dividing the advertisement time frame T11 in FIG. 8A into two equal time lengths, with each being one-half the time length of the advertisement time frame T11. In this case, bids are solicited with the minimum bid price set at 50 yen for each of the advertisement time frames T21 and T22.

When both of the advertisement time frames T21 and T22 have received winning bids of 50 yen or more in response to the bid solicitation using the layout specification T2 (i.e., an all-frame bidding success state), a deliverable containing advertisement images, sound, or the like of the winning advertisers is transmitted to the notification device, and the notification device performs a visual or audible notification based on the layout specification T2.

### <Layout Specification T3>

On the other hand, when the bid solicitation for the layout specification T2 does not produce an all-frame bidding success state, bids are resolicited using a layout specification T3 shown in FIG. 8C. Bidding results that do not produce an all-frame bidding success state include cases in which there are no bids for either of the advertisement time frames T21 and T22, cases in which there are bids for one of the advertisement time frames T21 and T22 but not the other, and cases in which there are bids for both of the advertisement time frames T21 and T22 but the bid prices for either of them are less than 50 yen.

In the layout specification T3, one advertisement time frame T31, which is of equal time length to the advertisement time frames T21 and T22 described above, and four advertisement time frames T32, T33, T34, and T35 are set in this sequence for the advertising time slot. Each of the advertisement time frames T32, T33, T34, and T35 is equivalent in time length to one division of the advertisement time frame T11 in FIG. 8A when divided into eight equal lengths or one division of either of the advertisement time frames T21 and T22 in FIG. 8B when divided into four equal lengths. In this example, bids are solicited with the minimum bid price for the advertisement time frame T31 set to 50 yen, which is the same price set for the advertisement time frames T21 and T22, and the minimum bid price for each of the advertisement time frames T32, T33, T34, and T35 set to 12.5 yen.

When the bid solicitation using the layout specification T3 produces an all-frame bidding success state in which all advertisement time frames T31-T35 have received winning bids at bid prices satisfying the corresponding minimum bid prices, deliverables of the winning advertisers, such as advertisement images, sound, and the like, are sent to the notification device, and the notification device produces visual or audible notifications based on the layout specification T3.

As described above, the advertisement time frame T31 in the layout specification T3 has the same time length as the advertisement time frames T21 and T22 in the layout specification T2. Therefore, when any bid for one of the advertisement time frames T21 and T22 offered when bids are solicited using the layout specification T2 is greater than or equal to the minimum bid price, i.e., when the winning bid conditions are satisfied for some of the plurality of advertisement time frames, the advertisement images, sound, or the like of advertisers having winning bids for these frames may be reassigned and delivered when performing visual or audible notifications based on the layout specification T3.

### <Layout Specification T4>

On the other hand, when the bid solicitation with the layout specification T3 does not produce an all-frame bidding success state, bids are resolicited using a layout specification T4 shown in FIG. 8D. Bid solicitation does not produce an all-frame bidding success state when no bids are received for any of the advertisement time frames T31-T35, bids are received for some of the advertisement time frames T31-T35 but not the rest, or bids are received for all of the advertisement time frames T31-T35 but at least one of the bid prices is lower than the minimum bid price, as in the above description.

In the layout specification T4, eight advertisement time frames T41, T42, T43, T44, T45, T46, T47, and T48 are set in this sequence for the advertising time slot. Each of these advertisement time frames T41-T48 is equivalent in time length to one division of the advertisement time frame T11 in FIG. 8A when divided into eight equal lengths or one division of the advertisement time frame T21 in FIG. 8B or advertisement time frame T31 in FIG. 8C when divided into four equal lengths. In this case, bids are solicited with the minimum bid price for each of the advertisement time frames T41-T48 set to 12.5 yen.

When the bid solicitation using the layout specification T4 produces an all-frame bidding success state in which winning bids are awarded for all advertisement time frames T41-T48 at a bid price that satisfies the minimum bid price, deliverables of the winning advertisers, such as advertisement images, sound, or the like, are sent to the notification device, and the notification device performs visual or audible notifications based on the layout specification T4.

As described above, each of the advertisement time frames T41-T48 in the layout specification T4 is equivalent in time length to the advertisement time frames T32-T35 in the layout specification T3. In other words, the time size of each of the advertisement time frames T41-T48 in the layout specification T4 is the same as the time size of each of the advertisement time frames T32-T35 in the layout specification T3. Therefore, when bids solicited using the layout specification T3 satisfy the winning bid conditions for at least some of the advertisement time frames T32-T35, the advertisement images, sound, or the like of the advertisers that bid on those frames may be reassigned and diverted when performing visual or audible notifications based on the layout specification T4.

In the variation shown in FIGS. 8A-8D, the advertisement time frames T11, T21, T22, and T31-T35 are each an example of the first delivery frame, and the advertisement time frames T21, T22, T31-T35, and T41-T48 are each an example of the second delivery frame. The time lengths of the advertisement time frames T11, T21, T22, T31-T35, and T41-T48 are each an example of the frame size. The layout specifications T1, T2, and T3 are each an example of the first piece of layout information, and the layout specifications T2, T3, and T4 are each an example of the second piece of layout information. The minimum bid prices of the advertisement time frames T11, T21, T22, and T31-T35 are each an example of the first frame condition, and the minimum bid prices of the advertisement time frames T21, T22, T31-T35, and T41-T48 are each an example of the second frame condition. The notification device is an example of the delivery destination device.

As in the embodiment described above, the layout specifications T1, T2, T3, and T4 provided with their respective advertisement time frames T11, T21, T22, T31-T35, and T41-T48 are stored in the storage unit 115 of the advertisement provision server 100, for example. Further, the order in which each set of layout information is used when sequentially soliciting and resoliciting bids as described above, i.e., the order of layout specification T1→T2→T3→T4 used in the bid solicitations for advertisement time frames in each layout specification Tis preset and the contents of this setting are stored in the storage unit 115. In this case, the advertisement provision server 100 may acquire specification information, performance information, or the like on the notification device, for example, and may select a layout specification suited to such information.

### (3) Other Variations

One or more of the following conditions may be added to the condition for a winning bid described above.

(i) Any layout specification does not include more than one advertisement image of the same design (i.e., all advertisement images to be included in the same delivery image have different designs from each other).

(ii) The orientation of all advertisement images are the same in each layout specification (i.e., all advertisement images to be included in the same delivery image have the same orientation as each other). In this case, the advertisement provision server 100 may retrieve only those advertisements from the advertisement management server 500 having a predetermined orientation. Alternatively, the advertisement provision server 100 may receive information on the orientation of each advertisement from the advertisement management server 500 and rotate the advertisements on the advertisement provision server 100 side to bring their orientations into alignment.

(iii) Each layout specification does not include more than one advertisement image for the same subject of advertisement (i.e., all advertisement images to be included in the same delivery image are related to different subjects of advertisement from each other). That is, advertisements often present the same product using different expressions. However, advertisements for the same content should not be included in the same layout specification, even when different expressions are used.

(iv) All advertisement images in each layout specification are information aimed at the same audience (i.e., all advertisement images to be included in the same delivery image are information targeting the same users). In other words, advertisement images targeting different users should not be included in the same layout.

In the above description, advertising information is used as an example of the information managed by the advertisement management server 500 and distributed to the advertisement provision server 100, but the information being managed and distributed may be other service content. Examples of such service content may be manga, images from novels, movies, thumbnail images from movies, and the like.

While the advertisement provision server 100 has been described above as a standalone device, a plurality of devices may operate in conjunction with each other to implement the functions of the advertisement provision server 100.

In the above examples, the advertisement provision server 100 creates a delivery image according to a layout specification, but the disclosure is limited to this configuration. Alternatively, the advertisement management server 500 may create a delivery image according to a layout specification. In this case, the advertisement management server 500 internally performs bidding and a subsequent winning bid process and then creates a delivery image according to a layout specification based on the bidding results. The advertisement management server 500 then transfers the created delivery image to the advertisement provision server 100. In other words, the entity that conducts bidding and the entity that creates the delivery image according to the layout specification may be the same.

The flowcharts shown in FIGS. 2 and 6 in the above description do not limit the present disclosure to the steps indicated therein. Steps may be added or deleted, or their order may be rearranged, without departing from the spirit and technical ideas of the disclosure.

In addition to what has already been described, the methods according to the embodiment and its variations described above may be used in suitable combinations.

In addition, although not illustrated individually, the present disclosure may be implemented with various modifications without departing from the spirit of the invention.

What is claimed is:

1. An information delivery system comprising:
a delivery destination device; and
a delivery provision server comprising:
a communication interface;
a memory storing therein a plurality of pieces of layout information including a first piece of layout information and a second piece of layout information, the first piece of layout information and the second piece of layout information being different from each other, the first piece of layout information defining one or more first delivery frames for placing information therein, each of the one or more first delivery frames being associated with a respective first frame condition, each first frame condition being a condition required for successfully bidding for the corresponding first delivery frame, the second piece of layout information defining one or more second delivery frames for placing information therein, each of the one or more second delivery frames being associated with a respective second frame condition, each second frame condition being a condition required for successfully bidding for the corresponding second delivery frame; and
a controller configured to perform:
a layout selection process including selecting the first piece of layout information from among the plurality of pieces of layout information stored in the memory;
a first information acquisition process including acquiring one or more pieces of first information for the one or more first delivery frames by acquiring at least one piece of first information for each of the one or more first delivery frames, each of the one or more pieces of first information being information satisfying the first frame condition of the corresponding first delivery frame;
a first determination process on the basis of the one or more pieces of first information acquired in the first information acquisition process, the first determination process including determining, for each of all of the one or more first delivery frames defined by the first piece of layout information, whether a piece of first information is placeable in the first delivery frame from among the at least one piece of first information acquired for the first delivery frame in the first information acquisition process;
a first creation process when determining in the first determination process for each of all of the one or more first delivery frames that a piece of first information is placeable in the first delivery frame from among the at least one piece of first information acquired for the first delivery frame, the first creation process including creating first delivery information in which the one or more first delivery frames are arranged according to the first piece of layout information and each piece of first information that is determined in the first determination process to be placeable is placed in the corresponding first delivery frame;
an information provision process in response to creating the first delivery information in the first creation process, the information provision process including providing the first delivery information created in the first creation process to the delivery destination device; and
a second information acquisition process when determining in the first determination process for at least one of the one or more first delivery frames that no piece of first information is placeable in the first delivery frame from among the at least one piece of first information acquired for the first delivery frame, the second information acquisition process including acquiring one or more pieces of second information for the one or more second delivery frames by acquiring at least one piece of second information for each of the one or more second delivery frames, each of the one or more pieces of second information being information satisfying the second frame condition of the corresponding second delivery frame.

2. The information delivery system according to claim 1,
wherein the controller is configured to further perform:
a first request process including transmitting a request for the one or more pieces of first information to a delivery management server through the communication interface; and
a second request process including transmitting a request for the one or more pieces of second information to the delivery management server through the communication interface,
wherein, in the first information acquisition process, the controller acquires the one or more pieces of first information in response to the request transmitted in the first request process through the communication interface, and
wherein, in the second information acquisition process, the controller acquires the one or more pieces of second information in response to the request transmitted in the second request process through the communication interface.

3. The information delivery system according to claim 1,
wherein the controller is configured to further perform:
a second determination process on the basis of the one or more pieces of first information acquired in the first information acquisition process and the one or more pieces of second information acquired in the first information acquisition process, the second determination process including determining, for each of all of the one or more second delivery frames defined by the second piece of layout information, whether at least one of a piece of first information and a piece of second information is placeable in the second delivery frame from among the one or more pieces of first information acquired in the first information acquisition process and the at least one piece of second information acquired for the second delivery frame in the second information acquisition process; and
a second creation process when determining in the second determination process for each of all of the one or more second delivery frames that at least one of a piece of first information and a piece of second information is placeable in the second delivery frame from among the one or more pieces of first information acquired in the first information acquisition process and the at least one piece of second information acquired for the second delivery frame in the second information acquisition process, the second creation process including creating second delivery information in which the one or more second delivery frames are arranged according to the second piece of layout information and each placeable piece of information is placed in the corresponding second delivery frame, the placeable piece of information being either one of a piece of first information determined in the second determination process to be placeable in the corresponding second delivery frame and a piece of second information determined in the second determination process to be placeable in the corresponding second delivery frame.

4. The information delivery system according to claim 3,
wherein all pieces of placement information, each of which is a piece of first information that is included in the same first delivery information created in the first creation process, satisfy at least one selected from the group consisting of the following requirements:
(i) all the pieces of placement information have different designs from each other;
(ii) all the pieces of placement information have the same orientation as each other;
(iii) all the pieces of placement information are related to different subjects of advertisement from each other; and
(iv) all the pieces of placement information are information targeting the same users.

5. The information delivery system according to claim 3,
wherein all pieces of placement information, each of which is a piece of second information that is included in the same second delivery information created in the second creation process, satisfy at least one selected from the group consisting of the following requirements:
(i) all the pieces of placement information have different designs from each other;
(ii) all the pieces of placement information have the same orientation as each other;
(iii) all the pieces of placement information are related to different subjects of advertisement from each other; and
(iv) all the pieces of placement information are information targeting the same users.

6. The information delivery system according to claim 1,
wherein the controller is configured to further perform:
an information saving process when determining in the first determination process for at least one of the one or more first delivery frames that a piece of first information is placeable in the first delivery frame from among the at least one piece of first information acquired for the first delivery frame, the information saving process including saving, in the memory, each piece of first information determined in the first determination process to be placeable.

7. The information delivery system according to claim 1,
wherein each of the one or more first delivery frames has a respective frame size and each of the one or more second delivery frames has a respective frame size, and
wherein at least one of the one or more second delivery frames has the same frame size as the frame size of one of the one or more first delivery frames.

8. The information delivery system according to claim 6,
wherein the controller is configured to further perform:
a third determination process including determining whether the piece of first information saved in the information saving process is placeable in at least one of the one or more second delivery frames.

9. The information delivery system according to claim 8,
wherein the controller is configured to further perform:
a determination process when determining in the third determination process that the piece of first information saved in the information saving process is placeable in at least one of the one or more second delivery frames, the determination process including determining to place the saved piece of first information in one of the at least one of the one or more second delivery frames.

10. The information delivery system according to claim 1,
wherein the number of the one or more second delivery frames is greater than the number of the one or more first delivery frames.

11. The information delivery system according to claim 1,
wherein each of the one or more first delivery frames has a respective frame size and each of the one or more second delivery frames has a respective frame size, and
wherein the frame size of one of the one or more first delivery frames is n times the frame size of one of the one or more second delivery frames, where n is an integer greater than or equal to two (2).

12. The information delivery system according to claim 3,
wherein the delivery destination device is a printer configured to perform:
receiving the first delivery information created in the first creation process or the second delivery information created in the second creation process; and
printing an image based on the received delivery information on a sheet.

13. A delivery provision server comprising:
a communication interface;
a memory storing therein a plurality of pieces of layout information including a first piece of layout information and a second piece of layout information, the first piece of layout information and the second piece of layout information being different from each other, the first piece of layout information defining one or more first delivery frames for placing information therein, each of the one or more first delivery frames being associated with a respective first frame condition, each first frame condition being a condition required for successfully bidding for the corresponding first delivery frame, the second piece of layout information defining one or more second delivery frames for placing information therein, each of one or more second delivery frames being associated with a respective second frame condition, each second frame condition being a condition required for successfully bidding for the corresponding second delivery frame; and
a controller configured to perform:
a layout selection process including selecting the first piece of layout information from among the plurality of pieces of layout information stored in the memory;
a first information acquisition process including acquiring one or more pieces of first information for the one or more first delivery frames by acquiring at least one piece of first information for each of the one or more first delivery frames, each of the one or more pieces of first information being information satisfying the first frame condition of the corresponding first delivery frame;
a first determination process on the basis of the one or more pieces of first information acquired in the first information acquisition process, the first determination process including determining, for each of all of the one or more first delivery frames defined by the first piece of layout information, whether a piece of first information is placeable in the first delivery frame from among the at least one piece of first information acquired for the first delivery frame in the first information acquisition process;
a first creation process when determining in the first determination process for each of all of the one or more first delivery frames that a piece of first information is placeable in the first delivery frame from among the at least one piece of first information acquired for the first delivery frame, the first creation process including creating first delivery information in which the one or more first delivery frames are arranged according to the first piece of layout information and each piece of first information that is determined in the first determination process to be placeable is placed in the corresponding first delivery frame;
an information provision process in response to creating the first delivery information in the first creation process, the information provision process including providing the first delivery information created in the first creation process to a delivery destination device; and
a second information acquisition process when determining in the first determination process for at least one of the one or more first delivery frames that no piece of first information is placeable in the first delivery frame from among the at least one piece of first information acquired for the first delivery frame, the second information acquisition process including acquiring one or more pieces of second information for the one or more second delivery frames by acquiring at least one piece of second information for each of the one or more second delivery frames, each of the one or more pieces of second information being information satisfying the second frame condition of the corresponding second delivery frame.
